(19) United States
(12) Patent Application Publication
(10) Pub. No.: US 2025/0067867 A1
(43) Pub. Date: Feb. 27, 2025

(54) SMART SURVEILLANCE DATA PROCESSING SYSTEMS FOR SAFE UNCREWED AIRCRAFT AND SURFACE VESSEL OPERATION BEYOND VISUAL LINE OF SIGHT

(71) Applicant: Accipiter Radar Technologies, Inc., Fenwick (CA)

(72) Inventors: Timothy J. Nohara, Fonthill (CA); Peter T. Weber, Burlington (CA); Graeme S. Jones, Waterloo (CA); John D. Sterritt, Welland (CA); Al-Nasir Premji, Burnaby (CA)

(73) Assignee: Accipiter Radar Technologies, Inc., Fenwick (CA)

(21) Appl. No.: 18/677,423

(22) Filed: May 29, 2024

Related U.S. Application Data
(60) Provisional application No. 63/578,539, filed on Aug. 24, 2023.

(51) Int. Cl. G01S 13/933; G01S 7/41; G01S 13/46; G01S 13/72; G06F 18/25; G08G 5/00; G08G 5/04

(52) U.S. Cl. CPC G01S 13/933; G01S 7/414; G01S 13/46; G01S 13/726; G06F 18/25; G08G 5/0069; G08G 5/0082; G08G 5/045; G01S 2013/464

(57) ABSTRACT

Smart surveillance data processing systems support safe uncrewed aircraft system (UAS) or uncrewed surface vessels/vehicles operations where remote pilots are operating their uncrewed aircraft beyond visual line of sight (BVLOS) or near controlled areas, by providing: (i) real-time situational awareness in dense crewed aircraft and uncrewed drone environments while providing automated detection and alerting of intruders to remote pilots in command; (ii) surveillance network performance assessments through radar and ADS-B quantifiable measures; (iii) detection and alerting of any appreciable degradation of surveillance sensor performance, allowing remote pilots to suspend or alter operations to ensure safety; (iv), standardized airspace reporting including traffic patterns; (v) certification of portions of the airspace where the surveillance network is capable of meeting a minimum standard; (vi) assessment and reporting of drone compliance and non-compliance with UAS operating regulations.

### CROSS-REFERENCE TO RELATED APPLICATION

This application claims priority to U.S. Provisional Application Ser. No. 63/578,539, filed Aug. 24, 2023, which is hereby incorporated by reference in its entirety.

### FIELD

This disclosure relates to smart surveillance networks which support large-scale, uncrewed aircraft system (UAS) operations and uncrewed surface vessel or vehicle (USV) operations where remote pilots are operating their uncrewed systems beyond visual line of sight (BVLOS), creating an increased risk of collision with other crewed or uncrewed aircraft, vessels and vehicles.

### BACKGROUND

Aviation is highly regulated to ensure aviation safety by minimizing the risk of accidents in the air or on the ground. Individual passenger and cargo aircraft are monitored by air traffic control (ATC), airlines, and other authorities using a combination of primary radar, sensors such as ADS-B (Automatic Dependent Surveillance—Broadcast), SSR (Secondary Surveillance Radar) and direct communication with pilots who always know where they are because of on-board global positioning satellite (GPS) sensors as well as by visually looking out through the windshield and flying in accordance with visual flight rules (VFR). SSR is used by ATC at many airports worldwide and relies on aircraft equipped with a transponder that replies to interrogation signals with encoded data such as an identity code and the aircraft's altitude. The SSR receiving system geo-locates the aircraft using range and bearing measurements on the transponder reply signal.

The airspace around airports is controlled by ATC; and crewed aircraft pilots are trained and cooperate with air traffic controllers to maintain safe separation from other aircraft and ground vehicles, thereby avoiding collisions that could result in loss of life and property damage, including loss of life and damage to people and property not involved in aviation. Air traffic controllers control the movement of aircraft as they approach and depart from an airport and while at the airport so they avoid collisions in the air, as well as on the ground in the movement area. Aircraft pilots are on board their aircraft and hence use VFR as another safety layer, keeping a lookout from their windows for other aircraft or vehicles that may intrude into their flight path, and adjusting speed, heading and altitude appropriately; and they also stay in communication with ATC as yet another safety layer.

ATC is aided by surveillance technology for improved situational awareness of aircraft at night, in the fog or weather, and at distance when controllers cannot see the aircraft by visually looking through the ATC tower glass; and also for busy and crowded situations where due to the number of aircraft, controllers would suffer from information overload in trying to keep traffic separated from each other using only their eyes. Primary ATC radar is designed to detect and track all aircraft in the certified surveillance volume of the radar (i.e., that volume where the radar is expected to perform well) whether the aircraft are non-cooperative (i.e., not carrying ADS-B or other GPS-based sensor on board for communicating their location to ATC in real-time) or cooperative. Due to land-use planning around an airport which minimizes line of sight (LOS) obstructions along designated arrival and departure corridors used by aircraft for approaching, departing and circling safely in the vicinity of an airport, a single, large, primary ATC radar plus SSR is the system of choice for providing aircraft coverage out to typically 60 miles from an airport.

Non-cooperative aircraft typically include smaller general aviation aircraft such as fixed winged and rotary aircraft (e.g., helicopters) which are often not required by regulation to broadcast their location to authorities in real-time. Pilots of non-cooperative aircraft use VFR and must follow aviation regulations and ATC instructions so they can operate safely within and outside of controlled airspace.

ATC primary radar is designed for high-availability due to its prominent role in aviation safety, and includes built-in test equipment to alert to radar faults requiring attention. For example, an antenna failure, transceiver failure or radar processor failure would generate alerts, and would automatically switch over to other hardware in redundant systems.

In addition, air traffic controllers implicitly validate radar system performance as they communicate with pilots at long distances by radio as well as look out the ATC tower glass at short distances to visually see closer aircraft, while observing the radar display that displays the aircraft tracks. Air traffic controllers will report any radar discrepancy they observe, namely, if their communications and observations are inconsistent with the tracks displayed on the radar screen. Hence, the air traffic controller is inherently a key part of performance verification of the radar system, helping to ensure that the situational awareness provided by the radar is reliable.

Integration of UASs or drones into the National Airspace is being considered by regulators and is particularly challenging because there is no pilot on board to use visual flight rules, the drones do not use ADS-B to communicate their positions to authorities in real-time, and they are not controlled by air traffic controllers. In fact, because air traffic controllers would be overwhelmed by the number of drones that could potentially fill the airspace, regulations are intentionally not allowing these small drones to use ADS-B. The present embodiments concern novel, radar-based, technological means to overcome these safety challenges posed by these new, non-cooperative and autonomous, small aircraft, which are difficult for pilots of crewed aircraft to see with their own eyes. New technological and regulatory means are needed to ensure continued aviation safety as drone use is expected to continue to grow exponentially.

The same or similar technological means are also applicable to commercial shipping, where today USVs or autonomous ships are being considered by regulators. Commercial shipping involves large cargo ships (typically defined as greater than 300 tons) such as salties (i.e. ocean going ships) and lakers (i.e. fresh water ships), and passenger ships such as ferries and cruise ships which are regulated and required to be cooperative with authorities by employing transponder sensors such as AIS (Automatic Identification System) and by pilot communication with Vessel Traffic Services (VTS) controllers when approaching or entering controlled seaports, shipping canals, and freshwater ports and rivers. Trained shipping pilots on board these ships use visual navigation (analogous to VFR) as well as on-board radar to help them navigate safely. The size of these regulated ships and their significant height above the waterline provide a reasonably stabilized (due to diminished ship motion, namely, pitch, roll and yaw) view of the local situation, given the high vantage point of the bridge of the ship where the pilot is typically located. Ship-based radar is also mounted high and with sufficient power to provide good line of sight and detection performance.

The challenge for USVs, which most often are expected to be relatively small in size similar to pleasure craft, and without a trained pilot on board, is the visibility of the local situation is poor making it much more difficult to safely avoid the overwhelming number of noncooperative pleasure craft on the waterways without new technological means.

The mid-air collision risk we are concerned about is not only between drones and crewed aircraft but also between uncrewed aircraft systems which becomes more problematic as drones become widespread. Unmanned Traffic Management (UTM) is a new frontier for air traffic control which will require new technological means including counter-UAS (C-UAS) sensors to provide the awareness needed for aviation safety.

Safety of navigation is also impacted by criminal behavior. Increasingly, cooperative aircraft and vessels turn their ADS-B or AIS sensors off or alter their true location when involved in nefarious activities they wish to conceal, requiring new technological means to detect and alert to these situations as remote pilots of uncrewed aircraft and vessels are no longer looking out the aircraft/vessel window during navigation.

And drones operating in an unsafe manner with remote pilots who are clueless or careless, as well as drones involved in criminal or illegal behavior add air-to-air collision risk and also impact the safety of lawful crewed aircraft (and vessels), drones as first responders (DFRs) and the public, requiring new technological means involving radar and RF-based sensors (such as radio frequency receivers) to detect and alert to these situations.

### SUMMARY

It is an aspect of the present disclosure to provide a system and/or an associated methodology that presents a remote pilot in command (RPIC) of a UAS or USV with surveillance-sensor-derived information, taken from the group of radar, ADS-B, AIS, C-UAS and RemoteID sensors, concerning aircraft or pleasure craft that intrude into the airspace or waterways where their uncrewed vehicle is operating, allowing the RPIC to operate their uncrewed vehicle BVLOS and maneuver their uncrewed vehicle appropriately to reduce the risk of collision.

It is a further aspect of the present disclosure to provide a system and/or an associated methodology that automatically provides specialized system performance assessment (SPA) data based in part on surveillance-sensor-derived information which is used to ensure that a surveillance system relied upon by an RPIC to detect and track intruder aircraft or intruder pleasure craft has not degraded from its designed or certified performance level.

Another aspect of the present disclosure is to provide a system and/or an associated methodology that automatically detects and alerts to any appreciable degradation of surveillance sensor performance, allowing remote pilots to take safety actions such as suspending or altering their operations.

Another aspect of the present disclosure is to provide a system and/or an associated methodology that provides automatically generated, surveillance-sensor-derived, air/vessel traffic and risk assessment reports to UAS/USV authorities and stakeholders characterizing noncooperative and cooperative air/vessel traffic patterns of interest to RPICs and regulators for risk-based, safety analysis, assessment and planning and in support of safety management systems.

An additional aspect of the present disclosure is to provide a system and/or an associated methodology concerning an authorized surveillance system service that provides for the automatic certification of portions of the airspace or waterways where a minimum intruder detection, tracking or alerting performance is available to RPICs.

Another aspect of the present disclosure is to provide authorities and stakeholders with regular, automatically generated, risk assessments of authorized UAS and USV operations in terms of their respective compliance with regulations, and which could support enforcement actions in the case of non-compliance.

A further aspect of the present disclosure is to provide real-time alerts to authorities of UAS and USV non-compliance with operating regulations and of suspicious UAS/USV activity allowing, enabling an immediate enforcement response concerning the particular non-complaint, uncrewed vehicle.

A final aspect of the present disclosure is to provide authorities and stakeholders with regular, automatically generated, risk assessments of authorized UAS and USV operations in terms of
their respective loss of separation statistics with respect to intruder aircraft or other uncrewed vehicles.

These and other aspects of the embodiments will be apparent from the drawings and descriptions included herein. However, it is not necessarily the case that every embodiment of the disclosure meets every object discussed herein.

It is also to be noted that while the UAS and USV applications will be the dominant applications used herein to illustrate the operational concepts, challenges, the innovations and their benefits of the present disclosure, they equally apply to other applications involving noncooperative targets that present safety or security challenges to remote operators, regulators, security personnel or stakeholders, including unmanned traffic management (UTM) and counter-UAS (C-UAS) applications.

While the surveillance-based embodiments taught herein are relevant to surveillance applications involving only cooperative, crewed and/or uncrewed aircraft or vessels which cooperatively broadcast their identity and location in real-time to support safe navigation, they are especially relevant and important for the applications focused on herein where noncooperative targets (i.e., aircraft or vessels, crewed or uncrewed) are also active in large numbers in the environment with unknown locations and behavior over large geographic regions. In these mixed-target-environment applications (i.e., when both noncooperative and cooperative targets are active in the surveillance environment), reliable, smart surveillance networks with radar sensors (including ones designed to specifically detect and track drones) and C-UAS sensors (e.g., radio frequency (RF) receivers, camera technologies, et cetera) are required in addition to cooperative sensors (i.e., ADS-B, AIS and RemoteID sensors) in order to detect and track these mixed targets and as well as provide the necessary, automated decision support to stakeholders to mitigate the risk of collisions with uncrewed aircraft or vessels and the threats posed by the use of uncrewed aircraft or vessels for nefarious purposes. These smart surveillance networks include specialized surveillance data processors that are able to automatically differentiate between cooperative and noncooperative targets, and to provide: (i) a unified and easy-to-comprehend, real-time awareness of the airspace and waterways, including intruder alerting, to stakeholders for safe navigation; (ii) automatic sensor performance assessment and health monitoring for assuring the ongoing health of the smart surveillance network relied upon by stakeholders; (iii) automatic traffic pattern analysis and understanding derived from the historical sensor data for mission planning, risk assessment and regulatory purposes; and (iv) automatic, real-time alerting to authorities of non-compliant, careless, clueless, illegal or criminal behavior of uncrewed aircraft or vessels to enable timely response and enforcement.

In the sequel, most of the disclosure will focus on the UAS mixed-target-environment application with a smart surveillance network that has both radar and ADS-B sensors; and will extend the teaching to other applications and to surveillance networks with a different sensor mix simply by reference, or with a brief explanation by analogy where warranted, so that it will be understood by those skilled in the art.

### BRIEF DESCRIPTION OF THE DRAWINGS

FIG. 1 is a block diagram of a smart surveillance network.

FIG. 2 is a block diagram of a real-time, specialized surveillance data processor incorporating the functionality of the MSC, TAX-TC, and DUNE.

FIG. 3 is an example of an automatically generated radar system performance assessment enabled by the MSC.

FIG. 4 is an example of an automatically generated ADS-B complimentary coverage analysis.

FIG. 5 is an example of an automatically generated standardized report of noncooperative aircraft traffic.

FIG. 6 shows an example of an automatically generated standardized report of cooperative aircraft traffic.

FIG. 7 is an example of an automated report showing drones in the airspace posing a risk to crewed aircraft.

FIG. 8 is an example of automated non-compliance report of an uncrewed aircraft.

### DETAILED DESCRIPTION

A smart surveillance network (also referred to as the “system”) as described here may be useful for providing support personnel and remote pilots in command (RPIC) of a UAS with BVLOS-specialized real-time situational awareness and alerting of intruder aircraft, or pleasure craft in the case of USVs, which pose a collision risk to their uncrewed vehicle, allowing the RPIC to maneuver the uncrewed vehicle (aircraft or vessel as the case may be) to a safe position.

The system may also be very useful for automatically and continuously, without human intervention, providing a specialized system performance assessment (SPA) of the radar sensor(s) or non-radar sensor(s) incorporated into the system as the case may be, to ensure that its ability to detect and track intruder aircraft, or intruder pleasure craft in the case of USVs, has not degraded from its designed or certified performance level. In this case, an SPA falling below one or more minimum risk-based performance thresholds would result in a maintenance call to troubleshoot and correct the problem and a partial or full suspension of or restrictions on uncrewed vehicle operations until the desired performance level is restored.

In addition, the system may also serve to provide regular (e.g., annual, monthly, daily, hourly, sub-hourly, or upon request), automatically generated:
a. Air traffic and risk assessment reporting to authorities and stakeholders of the airspace (or waterways in the case of USVs) characterizing non-cooperative and cooperative traffic patterns of interest to RPICs and regulators for risk-based, safety analysis and planning and in support of ensuring the efficacy of safety management systems; and
b. certification of portions of the airspace (or waterways) where a minimum intruder detection, tracking and/or alerting performance is available to RPICs from an authorized surveillance system service enabling RPICs to conduct uncrewed operations beyond visual line of sight (BVLOS) without visual observers (VOs), within the certified surveillance volumes.
c. certification of portions of the airspace (or waterways) by an authorized surveillance system service where the likelihood of encountering an intruder is less than a prescribed, risk-based threshold, enabling RPICs to conduct uncrewed operations (i) with visual observers (VOs), and (ii) beyond visual line of sight (BVLOS) without VOs, within identified and certified surveillance volumes designed to ensure the a priori risk of collision with an intruder aircraft or watercraft is acceptable.

The presently described system is also able to provide authorities and stakeholders with regular, automatically generated, assessments of authorized UAS and USV operations in terms of their respective compliance with regulations, for which detected failures could lead to enforcement actions. Furthermore, the automatically calculated, respective loss of separation determined in a probabilistic or statistical sense between intruder traffic and other uncrewed vehicles could raise safety concerns and provide a leading indicator that the risk of air-to-air collisions is increasing, serving as a critical part of a safety management system. This is especially important for aviation safety given the advocacy by the UAS community for right of away over general aviation aircraft and cooperative aircraft in certain air spaces. In addition, as drones increasingly fill the airspace, the risk of drone-to-drone collisions will naturally increase, which is why UTM is going to be so important in the future. Incorporating C-UAS sensors into the smart surveillance network to track noncooperative, uncrewed aircraft allows the aforementioned risk assessments, compliance assessments and loss of separation calculations and reporting to authorities and stakeholders to analogously apply for unmanned traffic management applications. And the same is true for the USV application where the same type of advanced processing capabilities are provided using track data from maritime radar and AIS sensors instead.

The aforementioned, novel capabilities which are described in greater detail herein will serve to enhance aviation safety and commercial shipping safety as uncrewed aircraft and surface vessels are more and more integrated into multi-modal transportation systems.

The present embodiments recognize that aviation safety in developed countries is presently achieved with relatively few accidents because of multiple layers of accident risk protection including (i) extensive regulatory compliance and training; (ii) on board pilots using VFR; and (iii) air traffic controllers using co-located visual and radar-based situational awareness. The present disclosure attempts to compensate for the fact that UAS/USV BVLOS operations lose both the on-board pilot's VFR safety layer and the traffic controller's co-located visual and radar-based situational awareness safety layer.

The far majority of small, commercial drones weigh 2 kg or less and professional drones can weigh up to 250 kg including payload. These drones are being proposed and used for various new applications such as inspecting infrastructure, small package delivery, facility security, and providing situational awareness for emergency responders. These drones are very difficult for crewed pilots to see with their eyes (i.e., with VFR) because of their small size, just like birds are difficult for aircraft pilots to see. Crewed aircraft strike birds regularly with thousands of bird strikes accumulated each year, and with many of them damaging, resulting in billions of dollars of losses along with complete aircraft destruction and loss of life in some cases. Most bird strikes occur below 500′ AGL.

Populating the skies with drones operating at low altitudes similar to birds can create a much higher risk of aviation accidents for the following reasons:
1. birds try to get out of the way of intruder aircraft; drones will not unless an RPIC is aware of the intruder and moves the drone out of harm's way; and
2. drones are denser than birds, especially their battery packs, which can be more damaging to aircraft bodies and engines.

ATC radar will not be of much help to RPICs and support personnel for intruder detection. The majority of authorized UAS operations will likely take place well away from major airports, say at least 10 km away, and these drones will fly at very low altitudes, typically less than 400 feet above ground level (AGL). Under these conditions, ATC radar coverage is typically not available because the nearest major airport with ATC radar is either more than 60 miles away, or the ATC radar is blind to general aviation aircraft such as crop dusters and helicopters when they are flying at low altitudes of say 500′ AGL or less, which they regularly do, and which brings them into conflict with drone operations.

The geometry, 500′ height AGL at 10 km range, represents a line of sight (LOS) vertical elevation angle of approximately one degree from the radar. This means that every object, such as a tree line, building, or terrain elevation difference (like a hill) anywhere within the 10 km interval to the ATC radar and presenting an LOS elevation angle greater than one degree to the radar, can result in a radar loss of coverage or LOS blindness in the direction of such objects. For example, a 60′ tree at 1 km distance or a 120′ hill or building at a 2 km distance from the ATC radar would represent such an obstacle and can cause the ATC radar to be blind in that direction to such low-flying intruder aircraft of concern to drone operations.

And for the case of operating USVs, most waterways do not have vessel traffic radars, where authorities rely mostly on VFR and AIS; and when radars are available at particular ports, the radar data is not available to RPICs but is rather used exclusively by vessel traffic controllers in their communications and management of cooperative, commercial shipping traffic.

The present disclosure seeks to overcome the aforementioned limitations by delivering new, affordable smart surveillance networks which incorporate practical and specialized surveillance data processing methods to help RPICs operate their uncrewed aircraft and vessels safely beyond visual line of sight and provide stakeholders with assurance of safe BVLOS operations without increased risk of collisions with crewed aircraft and vessels. These specialized surveillance data processing methods process the surveillance track data generated by the radar and non-radar sensors associated with a particular smart surveillance network.

For the sake of terminology used herein, a radar surveillance network or simply radar network includes multiple radars at different locations and may include one or more other cooperative sensors such as ADS-B, AIS or Remote ID (as discussed hereinafter). A non-radar surveillance network would include multiple cooperative sensors such as ADS-B, AIS or Remote ID, but not include any radars. A smart surveillance network or simply surveillance network could mean any combination of sensor types and numbers of sensors. The practical and specialized surveillance data processing methods taught herein may process data from sensors (radar and/or cooperative sensors) from a single site or node, or in a network configuration where multiple sites or nodes are involved. The context will make it clear in each case.

In the sequel for ease of presentation, the embodiments will be described in the context of UAS operations, but apply similarly to USV operations. Differences between these applications will be pointed out in some circumstances.

Regulators have called on detect and avoid systems that can be proven effective for alerting RPICs to approaching intruder aircraft, thereby giving the RPIC sufficient time to maneuver their UAS into a safe position and thus avoid the potential for collision with low-flying general aviation aircraft. Employing sensors such as radar(s) and camera(s) on-board the drones to provide the detect and avoid function is one approach that is being successfully used in specific cases. The challenge there is that the detect and avoid sensors add weight and significantly impact the design and cost of the drones, and the sensor motion as a result of being onboard the drone adds processing complexity and cost. Another approach is ground-based detect and avoid where the surveillance sensors are deployed on land. This latter approach is assumed by the present embodiments although much of the innovative, smart surveillance data processing methods could be applied for on-board detect and avoid systems as well.

Ground-based detect and avoid surveillance technology has been successfully used by many applicants in the United States and other countries to obtain permission from regulators to operate a UAS beyond visual line of sight. In most of these cases, BVLOS operations are being carried out at a specific site where one or more co-located radars are providing a single surveillance volume within which one or two drones will fly and intruders will be detected. And while there are a few projects or initiatives where a small network of a few widely separated radars has been proposed to provide regional or state corridors where any number of unrelated (i.e., not employed by the same company) commercial RPICs could fly their drones, there is virtually no public information available on how these radar surveillance networks function to enable safe BVLOS operations for multiple, unrelated RPICs and UASs. The present application is intended to address this gap by describing how affordable, high-performance, wide-area, terrestrial radar and non-radar surveillance networks can be designed and deployed to maintain aviation safety (and ship navigation safety) as UASs (and USVs) expand in terms of widespread use.

The present embodiments assume that a radar network monitors the desired airspace (or waterways) in real-time and retains historical target data (i.e., detection and track data) for all tracked targets in a database that can be quickly searched for data of interest. For example, see U.S. Pat. No. 7,940,206 B2 which describes radar systems that can be used for this purpose, which is incorporated by reference. While the present embodiment may be applicable for the case of a single radar system, it has particular design features for wide-area networks with multiple radars with overlapping coverage to create a large, continuous surveillance volume, similar to a cellular network for continuous cell phone usage throughout a region without gaps in coverage.

The wide-area surveillance network can be made up of radar sites or nodes employing virtually any 2D radar sensor or 3D radar sensor preferably in the microwave band (with magnetron or solid-state transceivers), typically from L-band to Ka-band, capable of reliably detecting and tracking intruder aircraft (or vessels for USVs) with sufficient spatial resolution for collision avoidance. Modern X-band solid-state radars are particularly effective, easy to deploy because of their relatively light weight and good performance in weather, and affordable. The radars can all be of the same brand, or they could be different. Various affordable, commercial-off-the-shelf (COTS) radars could be used, potentially with add-on, third-party, radar signal/data processors with high-quality detection and tracking for small aircraft as well as pleasure craft. For illustration purposes only, they could be long-range, 2D Terma SCANTER 5000 series IALA radars, mid-range 2D Furuno or JRC solid-state IMO radars or 3D Echoshield radars, or short-range 3D Echoguard radars. Again for illustration purposes only, long-range, medium-range, and short-range radars might provide reliable, small intruder detection out to 30 km, 10 km and 3 km, respectively. The 2D radars provide good position (latitude, longitude) information, and the 3D radars also provide good altitude information.

The radar network design or set of locations for the radar nodes depends on a number of factors including the size/shape of the desired operational airspace (or waterways) to be covered for intruder detection, the geography (e.g., flat or varied, rural, urban or a mixture), and the availability of suitable/accessible radar sites with power, networking, mounting infrastructure (e.g., roof-top, small-pole, tower), and permitting (i.e., radio frequency authorization as well as local municipal permitting).

While fewer long-range radars would in theory be needed to cover a given sized airspace, many sub-regions of that airspace would likely be blind due to LOS obstructions as described above with respect to ATC radars. For this reason, except for airspaces over flat, rural areas or maritime areas, medium-range and short-range radars are likely to form part of the wide-area radar network. Due to the number of short-range radars needed as compared to medium-range radars (approximately 10 times more for the same geographic area using the aforementioned small intruder detection ranges) and hence the number of sites that would need to be developed with associated costs, medium-range radars will likely ultimately be preferred for large-scale rollouts, with short-range radars used as gap-fillers and long-range radars used where LOS blindness for the UAS (or USV) operations of interest is limited.

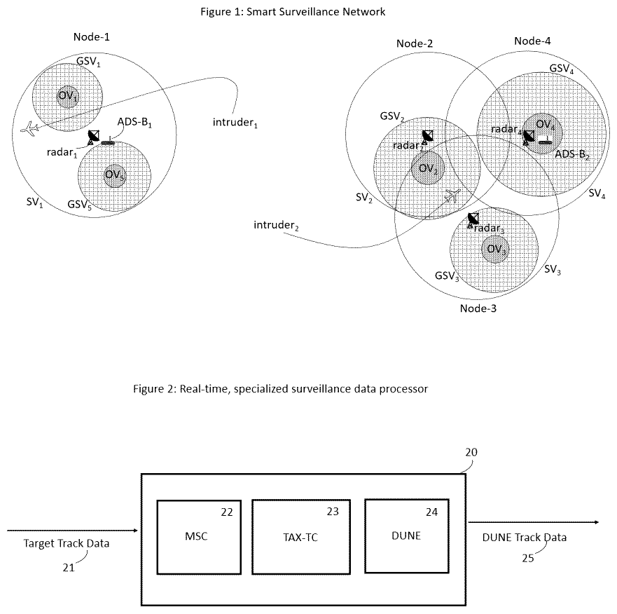

Let's take an example to help illustrate the embodiments. Consider a small, wide-area, terrestrial, radar surveillance network consisting of four radar sites or nodes, with two of them also having ADS-B receivers to collectively provide a regional airspace within which multiple, unrelated RPICs can conduct simultaneous UAS operations safely. The smart surveillance network is illustrated in FIG. 1 which provides a birds-eye or overhead view of the composite, radar surveillance volume (CRSV) indicated as SV₁, SV₂, SV₃, SV₄. For the purposes of this example, each of the four radar sites uses the same, medium-range radar with a 10 km intruder detection range, where small, low-flying general aviation aircraft will be detected and tracked reliably. Node-1 and Node-4 both include an ADS-B sensor (i.e., receiver) in addition to their respective radar sensor. The Node-1 radar's 10 km intruder surveillance volume (SV) is well separated from the SVs of the other three nodes which have overlapping coverage as illustrated in FIG. 1, indicated by their respective 10 km range circles represented with solid lines.

This regional surveillance network is able to support multiple unrelated RPICs carrying out their respective, unique, BVLOS drone operations by providing each of them with the real-time situational awareness of aircraft in their respective vicinity and real-time alerts when an intruder aircraft comes too close to where they are operating their respective uncrewed aircraft. To achieve this capability, the real-time aircraft tracks generated from the various 2D/3D radar and ADS-B sensors need to be integrated and displayed in real-time in software overlaid on top of a built-in map using earth coordinates such as {latitude, longitude, altitude} or Universal Traverse Mercator coordinates. This common earth coordinate system is beneficial so that multiple RPICs operating from different locations which are distinct from the sensor locations and from where their drone operations are occurring can visually understand where their uncrewed aircraft is relative to other aircraft as well as the in relation to their earth-based mission. We refer herein to this integrated display software as a common operating picture (COP).

ADS-B sensors naturally report in 3D earth coordinates because they use GPS as the basis for reporting positions. 2D and 3D radars, however, naturally and typically report detected target positions in local radar coordinates such as slant-range, azimuth (from the particular 2D radar location) or slant-range, azimuth, elevation (from the particular 3D radar location); and then through multi-target tracking algorithms transform these coordinates to earth coordinates. While the 3D radar has a one-to-one mapping between local radar coordinates (slant-range, azimuth, elevation) and earth coordinates (latitude, longitude, altitude), there is no unique mapping for 2D radars because of the target altitude uncertainty caused by the lack of a precise elevation angle estimate for each detected target. In order to map to earth coordinates using a 2D radar so that tracked targets can be displayed on a common map, we may need to make an assumption. If the 2D radar is used to track mostly vessels, then we might assume that slant-range equals ground range (i.e., elevation angle=0 degrees representing the local horizontal plane). For applications like the BVLOS application where aircraft are the targets of interest, we might alternatively select the mid-beam elevation angle as the default angle for earth coordinate transformation and display purposes (e.g., for a 20-degree fan beam antenna spanning 0 to 20 degrees relative to the horizontal plane, assume that the elevation angle for all detected targets is 10 degrees).

Now continuing with the example, ADS-B detection range using a good ADS-B receiver is typically well beyond 200 km in practice and therefore the two ADS-B receivers in FIG. 1 provide overlapping ADS-B coverage throughout the entire illustrated airspace since node-1 and node-4 are less than 100 km apart. This is helpful because ADS-B receivers can also have radio frequency (RF) blind areas where significant obstructions such as a tree line or even multipath can inhibit reception of cooperative aircraft broadcasts. By having overlapping coverage and combining the ADS-B feeds as described hereinafter, we can ensure reliable ADS-B coverage of all cooperative aircraft that may intrude on UAS operations in the operational airspace.

Next consider the two operational volumes (OVs) associated with Node-1 and the three OVs associated with Nodes 2, 3 and 4 where drones are flown by RPIC's to carry out their respective UAS operations in accordance with their mission (e.g., infrastructure inspection, delivery of goods, security patrols, et cetera). The OVs are the dotted-pattern-filled areas in FIG. 1.

Now for an RPIC to be alerted to an intruder aircraft with sufficient time for the RPIC to command its drone to a safe location until the threat has moved away, the intruder alert must be provided well in advance of the intruder entering the OV. One approach would be to calculate the time budget needed for the RPIC to (i) receive the intruder alert, (ii) decide on a safe maneuver, (iii) issue the safe maneuver command to the drone and (iv) have the drone move and arrive at the safe holding position; and then apply this time budget to the fastest incoming intruder to calculate a safe separation distance. This safe separation distance could then be used to provide a safety buffer around each OV defining a go safe volume (GSV). If the radar network issued an alert to an RPIC whenever an intruder was detected entering its GSV, the RPIC would then have sufficient time to safely move its drone out of harm's way. For illustration purposes, assume the GSV provides a 2-mile buffer around each OV. The GSVs are illustrated for this case in FIG. 1 as the hashed areas surrounding each OV and denoted as GSV₁ to GSV₅.

Before proceeding further with the example, we note that the GSVs described thus far are fixed in relation to a particular OV. However, in a particular embodiment, we can also implement a dynamic GSV for each UAS with access to its GPS or Remote ID (as required by the Federal Aviation Administration) signal in real-time, which indicates the UAS's location at any instant in time. For this case, the safe separation distance would be added as a horizontal buffer to the instantaneous location of the UAS, essentially providing a moving or dynamic circular buffer around the drone for which intruder alerts would be automatically generated and provided to the RPIC.

While a 2-mile horizontal buffer might be needed around the OV because of the high speed of some intruder aircraft (e.g., 120 knots), a much smaller separation distance is needed vertically because general aviation aircraft do not descend in elevation anywhere near as quickly as they move horizontally. In the example, if an aircraft is flying at a height of say 1,000′ or more above a low flying, uncrewed drone, the aircraft would not be considered an intruder. Let's build on the FIG. 1 example. Let's assume that in all cases, the drones are flying no higher than 400′ AGL. In this case, the OVs illustrated in FIG. 1 would have a height of 400′ AGL; i.e., the drones operational volume is restricted to 400′ AGL. If we then build in a vertical buffer of say 1,000′, the GSVs in FIG. 1 would have a ceiling of 1,400′ AGL. In other words, if an aircraft flew horizontally into the GSV's volume, i.e., within its horizontal extent and at an altitude of 1,400′ or less, the aircraft would be considered an intruder and an intruder alert would be generated by the radar network. However, if we knew that aircraft was flying above 1,400′ AGL, then it would not be considered an intruder and an intruder alert would not be generated because the aircraft could be expected to remain well clear of the drone vertically as it flew through the horizontal extent of the GSV.

Next, we turn to the altitude profile of a radar's SV, which is dependent on the radar's vertical or elevation antenna pattern. While 3D radars can often scan in elevation from the horizon up to 80 degrees above the horizon (i.e., almost hemispherical), most medium-range and short-range 2D radars with a mechanically rotating array antenna provide about a 20-degree elevation beam. Long-range 2D radars with specialized cosecant-squared antennas can typically provide 60 degrees of vertical coverage with a very wide elevation beam similar to ATC radars.

In light of this, a 2D medium-range radar with a 20-degree elevation beam (oriented from the horizon to 20 degrees above the horizon) would have a large cone of silence (where it does not detect aircraft) beginning at the radar and defined by the 20-degree elevation angle. At the 10 km SV distance, the beam coverage would reach from ground level to approximately 12,000′ AGL (i.e., 32,808′*tangent(20⁰)) and beam coverage would be from ground level up to 1,400′ AGL a distance of approximately 1.17 km from the radar.

A 3D radar with 80 degrees of elevation coverage, on the other hand, would have a cone silence just a fraction of this size, with ground level to 1,400′ AGL being covered just 75 m distance from the radar. This is why short-range 3D radars are good for filling gaps in SV coverage where needed. The notional 3 km intruder detection range described earlier, and the very small cone of silence mean that intruders can be tracked continuously at all altitudes of concern throughout this volume of coverage.

However, it should be noted that where a pair of 2D radars have overlapping coverage, the cone of silence associated with one radar can be covered by the coverage pattern of an adjacent radar a few kilometers away, very much like adjacent cellular base station radios work together to ensure coverage through a composite region. In this case, a gap filler radar is not needed. Alternatively, if an intruder is detected flying into a GSV and then is lost as it gets closer to the radar and flies into its cone of silence, it would typically only take a short while for the intruder to be picked up again as it exits the cone silence on the other side of the radar. For an intruder flying 60 m/s, it would only take approximately 40 seconds to cross the 2×1.17 km=2.34 km distance to clear the cone of silence. In this case, the RPIC could simply descend to a safe position and wait out the 40 seconds for the intruder to clear the cone of silence before resuming operations, again, without the need for a gap filler radar.

With the above details, we are now ready to discuss how automated alerts can be generated in real-time in accordance with the embodiment to alert the RPIC to the presence of an intruder in the GSV so that action can be taken to mitigate the risk of an air-to-air collision. The radar network described above provides the surveillance means for detecting and tracking aircraft in the airspace and includes a specialized surveillance data processor which provides the data processing means for detecting an intruder entering, appearing in, or exiting a particular GSV and automatically generating and issuing alerts. For a particular GSV, the radar network can issue automated intruder alerts determined by using one or more radars or data sources each providing complete or partial coverage of the GSV, one or more ADS-B receivers or data sources each providing complete or partial coverage of the GSV, or a combination of both types of sensors/data sources.

Consider, with reference to FIG. 1, intruder₁ entering GSV₁ for the case where the intruder₁ aircraft is equipped with ADS-B and broadcasting its identifier and location information typically once per second; and where the ADS-B receiver associated with Node-1, referred to hereinafter as ADS-B₁, receives these ADS-B broadcasts and makes them available, typically in the form of an ADS-B track, to the radar network for further processing. Furthermore, the medium range 2D radar associated with Node-1, referred to hereinafter as radar₁, also detects and tracks intruder₁ and makes the intruder₁ track available to the radar network for further processing. In this case, the radar network detects intruder₁ entering GSV₁ from both radar₁ and ADS-B₁. If the intruder₁ ADS-B₁ track reports an altitude greater than 1,400′ AGL, then the ADS-B₁ track will not cause the radar network to generate a GSV₁ alert, but the intruder₁ radar₁ track will cause a GSV₁ alert to be generated by the radar network because its altitude is unknown (because the radar tracks is from a 2D radar) and must be presumed to be in the GSV for reasons of safety. If intruder₁ is flying at or below 1,400′, a second GSV₁ alert will be generated in response to its ADS-B₁ track. In other words, for a given GSV, the radar network will generate an independent intruder alert for each sensor feed (i.e., stream of tracks) or data source, absent any further specialized data processing as described hereinafter.

Next consider intruder₂ entering GSV₂ shown in FIG. 1. Radar₂, associated with Node-2 and radar₃ associated with Node-3, both pickup and generate respective tracks for intruder₂ as it enters GSV₂ due to designed overlapping covering of these radars. Also assume that only the ADS-B₄ receiver associated with node-4 is used in this example by the radar network to monitor cooperative aircraft. As a result, the radar network will generate three different GSV₂ alerts when intruder₂ enters GSV₂, for the case where intruder₂ is flying at 1,400′ or less when it enters the GSV₂, one from each of the radar₂ and radar₃ feeds, and the third from the ADS-B₄ feed.

A couple of observations are in order. First, extra, unnecessary alerts are generated even when the intruder is outside of the GSV because of altitude uncertainty associated with the 2D radar(s) as well as because ADS-B is being used in addition to radar. Second, we are taking a belt and suspenders approach for safety by using both ADS-B and radar here. ADS-B is available to reliably assess the commercial traffic, and to provide redundancy in case of radar failure or lack of coverage in a certain area. And radar provides the ability to detect and track general aviation aircraft not carrying/broadcasting ADS-B; and provides redundancy in the case of an ADS-B failure or lack of coverage in a certain region. But the consequence of using 2D radar as well as ADS-B is a significant reduction in RPIC operational efficiency because of these extra alerts generated when the intruder is at an altitude above the GSV. These extra alerts, referred to hereinafter as alert multiplication, force the RPIC to move the drone to a safe position and wait or abort a mission until the intruder clears the volume above the GSV airspace, representing a direct loss in mission time or operational efficiency. Further innovations associated with the embodiments described hereinafter are directed to regaining this loss in operational efficiency that is a consequence of wanting increased aviation safety, redundancy and resiliency while conducting uncrewed operations.

It is worth pointing out that it is prudent from a safety perspective for the radar network to use both the ADS-B₁ and ADS-B₄ receivers to provide overlapping ADS-B coverage and redundancy in case of failure or degraded performance of one of them. ADS-B transmits using RF frequencies (e.g., 1090 MHz) and is constrained by LOS obstructions similar to radar, and these obstructions can vary seasonally as trees regain their foliage in the spring. Using multiple ADS-B receivers also provides resilience against jamming as discussed further below. Fortunately, alert multiplication can be avoided when using multiple ADS-B receivers because a specialized ADS-B data processor in accordance with the embodiment can join/combine the ADS-B tracks from each receiver in real-time using the aircraft identifier provided for in the ADS-B standard thereby creating a single, composite ADS-B track data stream or feed containing a single ADS-B track for each cooperative aircraft (rather than multiple) with a desired track update rate. This composite ADS-B feed can then be preferably used by the radar network's specialized surveillance data processor for alerting on GSV intrusions, and for any or all other ADS-B data processing.

Regulators are starting to allow certain BVLOS operations to be carried out with detect and avoid capabilities solely based on ADS-B; i.e., radar is not required at all. For example, in the case of low-altitude shielded operations where a drone is flying well below 400′ AGL and within say 100′ of a linear ground structure such as electric power feeder or distribution line, the RPIC is only required to rely on ADS-B for BVLOS operations; and must maneuver to a safe position only when an ADS-B carrying intruder is detected. General aviation aircraft not carrying ADS-B are being required to stay well clear above say 500′ AGL and to yield to drones carrying out shielded operations. Indeed, this is one way to share the skies between drones and general aviation aircraft. However, if the ADS-B system fails for any reason including jamming, the RPIC will not be aware of the intruder aircraft and hence will not yield by maneuvering to a safe position, creating an increased risk of an air-to-air collision.

ADS-B electronics can fail like all electronics for numerous reasons known to those skilled in the art; and a good preventative maintenance program can reduce the occurrence of hardware and software failures. Jamming, on the other hand, is intentional and malicious in nature and cannot effectively be mitigated preventatively.

Jamming ADS-B is inexpensive and easy and is becoming increasingly problematic because ADS-B jamming technology is readily available off-the-shelf, and further because terrorism, economic disruption, mischief, and the desire to not be tracked by authorities are all on the rise.

Radar jamming, on the other hand, is typically expensive and difficult for reasons known to those skilled in the art, including proprietary waveforms and signaling, as well as the built-in ability to reject clutter and co-channel radars by design.

ADS-B typically relies on GPS (Global Positioning System) L-band signal reception (between 1 to 2 GHz) on the aircraft of satellite transmissions about 20,000 km away, which is a key part of the aircraft's real-time navigation system which determines the aircraft's position over time. ADS-B broadcasts the aircraft's position using RF broadcasts that are typically at 1090 MHz and occur at a 1 Hz rate or more; and these broadcasts from the aircraft, which include the aircraft's identifier information in addition to the aircraft's position information, can be picked up by ADS-B receivers as far as 400 km away. The ADS-B broadcasts are not encrypted and follow standards allowing virtually anyone to receive them.

An airborne or ground-based jammer can easily interfere with the reception of GPS signals on aircraft in a region because the jammer is much closer (say <10 km away) as compared to the GPS satellites which are ˜20,000 km away. Hence, the GPS jammer has a huge power advantage that can deny aircraft navigation systems on aircraft in the vicinity of the jammer from knowing their respective positions (latitude, longitude, altitude) of their respective aircraft. Without reliable aircraft position information, ADS-B does not work.

An airborne or ground-based jammer can also similarly interfere with an ADS-B receiver's ability to receive the ADS-B broadcast pings from aircraft in the vicinity. An ADS-B receiver is intended to cover a region that could extend in range as far as ˜400 km away. Studies predict that a jammer within 1 km of an ADS-B ground-based receiver could deny that receiver's ability to properly function; and limit its jammed coverage volume to aircraft located within say 3 km of that ADS-B receiver, resulting in huge gaps introduced into the otherwise regional ADS-B coverage volume¹. To mitigate this large gap where aircraft may go undetected, a dense network of ADS-B receivers may be used within each regional ADS-B coverage volume, each spaced from the other so that it is only responsible for a jammed coverage volume spanning a short range of say 3 km. Spacing adjacent ADS-B receivers say 6 km apart would ensure resilience to jamming virtually anywhere. And the aforementioned specialized ADS-B data processor should be designed to work robustly whether or not jamming is impacting the integrity of the ADS-B sub-system of the BVLOS surveillance network. ¹ Leonardi et al, 2014 http://ieexplore.ieee.org/document/6945445?arnumber=6945445

For resiliency against jamming and ADS-B failures, radar is also proposed to serve as a backup to ADS-B, even where radar is not required by regulators, just like it does at airports.

In light of the above, BVLOS surveillance networks providing intruder detect and alert capabilities, in support of the detect and avoid function, should use radar as backup to ADS-B, or alternatively when radar is not required by regulators, should use a network of ADS-B receivers spaced a few kilometers apart rather than on order of a hundred kilometers apart, to ensure continued aviation safety in the presence of ADS-B failures or jamming. And in a preferred embodiment of the BVLOS surveillance networks, these backup/redundant sensor capabilities are built into the BVLOS-specialized real-time situational awareness and alerting data processing introduced above and further taught hereinafter.

This specialized surveillance data processing continues to function seamlessly in the presence of equipment failures and/or jamming, it eases RPIC workload and reduces alert multiplication to keep operational efficiency high, it draws RPIC attention to when the BVLOS surveillance network is performing sub-optimally, and it operates on the big data produced by the surveillance network to provide automated, analytical risk and compliance assessments, reporting and alerting to stakeholders.

In short, the BVLOS surveillance networks feature smart radar data processing devices and methods to enable RPICs to safely and efficiently carry out uncrewed operations beyond visual line of sight, regardless of the sensor makeup of the BVLOS surveillance network.

Building on the example in FIG. 1 where intruder₂ entered and left GSV₂ causing both radar₂ and radar₃ to generate intruder alerts, multi-radar fusion, can combine/fuse the tracks from radar₂ and radar₃ before processing any GSV₂ alerting functionality. As a result, a single, fused radar track for aircraft intruders could be maintained on intruder₂ as it approaches, enters and departs from GSV₂, thereby issuing only a single GSV alert to the RPIC, notwithstanding that radar₂ first picked up the intruder and then dropped it, with radars taking over until the intruder left the critical airspace. Multi-radar fusion, as illustrated in this example, mitigates alert multiplication and consequently helps restore operational efficiency, which is a significant benefit for BVLOS surveillance networks requiring multiple radars with overlapping coverage.

Multi-radar fusion can work with both 3D radars and 2D radars. For 3D radars, as the aircraft tracks have {latitude, longitude, altitude} position information, associating tracks from two or more radars with the same aircraft target is straightforward using association, prediction and filtering methods. 3D radar fusion for aircraft whose trajectories are 3D in nature is similar to 2D radar fusion for vessels, whose trajectories are 2D in nature {latitude, longitude} and constrained to the water surface.

In accordance with a preferred embodiment, specialized multi-radar fusion processing algorithms are designed for 2D radars which are preferred for BVLOS applications as described earlier. This includes specialized slant-range processing algorithms which incorporate the respective elevation angle uncertainty to a potential common target seen simultaneously by two or more 2D radars, and mathematically search or solve for a possible slant-range plane intersection. Since 2D radar tracks are typically represented in earth coordinates to begin with, they will typically require transformations back to local radar coordinates, or they will require maintaining local radar coordinates along with the earth coordinate tracks so the fusion processor has access to them. Practically speaking, since the fusion processing is preferably done at the surveillance network's centralized processing facility where radar and ADS-B sensor data are fed to specialized data processing servers in real-time, the preferred approach is to send both local radar coordinates and transformed earth coordinates data from each 2D radar site to the centralized processing facility.

Not only does this specialized 2D multi-radar fusion algorithm fuse 2D aircraft tracks, but if done properly (accounting for range, azimuth and elevation resolutions as a function of target location) it also can generate a height estimate for the fused target, providing the missing third dimension. This real-time generated height estimate is used to create complete earth coordinates {latitude, longitude, altitude} for the fused tracks which can then be used for better GSV alerting, including not alerting when the fused track is flying above the GSV ceiling of 1,400′ AGL in this example. As a result, the specialized multi-radar fusion processing, which we refer to herein as a radar fusion engine (RFE), also gains back the operational efficiency lost with the use of 2D radars, effectively behaving like a 3D radar where-ever the height-estimation algorithm converges. Practical deployments of fusing multiple 2D radars to get fused 3D target trajectories is new. And real data from such networks combined with theoretical association and fusion algorithms has been deficient in some applications. As a result, a preferred RFE embodiment incorporates multiple additional processing steps to obtain the desired performance. First, if MSC processing is available, the radar track feeds that the RFE operates on would be pre-filtered to remove any radar track updates which the MSC has correlated with ADS-B, so that the RFE effectively only operates on radar tracks from noncooperative targets. Second, where TAX-TC processing is available, additional pre-filtering is applied to the RFE input tracks to remove bird tracks and clutter tracks and only provide radar tracks consistent with aircraft. Finally, special algorithms are preferably employed to bias down the resulting 3D height estimates, ensuring a height estimate is equal to or lower than the true target height so that we don't make a mistake by inhibiting a GSV alert due to an estimate that is higher than the true target altitude. We don't want an accident. The practical consequence is that we will regain some but not all of the lost operational efficiency associated with using 2D radars in lieu of 3D radars.

A multi-sensor correlator (MSC) in accordance with an embodiment, is another specialized radar data processor that would typically run at the surveillance network's centralized processing facility which automatically determines which radar tracks (non-fused or fused) are likely from the same aircraft for the case where the aircraft is broadcasting ADS-B. As most aircraft carry ADS-B, a high proportion of radar tracks can be expected to come from ADS-B carrying aircraft; i.e., cooperative aircraft. With 2D radars, the MSC uses correlation algorithms that correlate 2D (preferably slant-range, azimuth) radar tracks with 3D ADS-B tracks which provide numerous downstream data processing benefits as described below. The MSC also works for 3D radars, correlating them with ADS-B tracks. The MSC preferably marks (i.e., tags) correlated radar tracks with their respective ADS-B track identifier, which serves multiple purposes such as: (i) allowing the COP to overlay both radar and ADS-B tracks and indicate on the radar track (with a symbol or annotation) whether or not it has been determined to be correlated with an adjacent and nearby ADS-B track; (ii) it supports smart downstream data processing including with the DUNE described below, and (iii) it remains in the historical data supporting all kinds of queries, data analytics and system performance assessment (SPA) processing. A variety of correlation algorithms known to those skilled in the art can be used by the MSC to correlate radar tracks with ADS-B tracks. This real-time processor will preferably establish correlation over a moving time window on the order of a several seconds involving multiple, say N, radar track updates (e.g., the current update along with N−1 previous updates) to confirm correlation in accordance with the required reliability. As with most radar data processing due to measurement uncertainties and signal-to-noise ratio factors, there is a trade-off between latency (how quickly a new radar track can be determined to be correlated with a particular ADS-B track which depends on the duration of the moving time window) and reliability (how confident we are that the correlation is valid). In one preferred embodiment of the MSC, each newly received radar track update is compared to the most recent ADS-B track update (or composite ADS-B track update) predicted forward to a common update time, and the geographic locations of these two respective track updates are compared and tested for sufficient correlation. With 3D radar tracks, correlation is easily determined using x, y, z or latitude, longitude, altitude locations. With 2D radar tracks, special methods are required as the respective pair of track locations involve 2D coordinates (range, azimuth) for the radar track update and 3D coordinates (latitude, longitude, altitude) for the ADS-B track update. There is a locus of locations that the radar track update could be associated with. To solve this ambiguity, we take the altitude of the ADS-B track update and use it as a constraint to calculate a 3D coordinate from the 2D radar track update, and then we compare this calculated 3D radar coordinate with the ADS-B coordinate to test for correlation. The correlation test could generate a 0 for an uncorrelated result for this update time and a 1 for a correlated result; and an M/N test across the correlation window using the current update correlation test and the previous N−1 tests could be used to establish correlation. Alternatively, a linear sum or sum of squares correlation test could be calculated across the correlation window with a resulting correlation error or distance metric calculated and compared against a threshold for each time update.

A Target Attribute eXtractor—Target Classifier (TAX-TC) in accordance with an embodiment, is another specialized radar data processor that would typically run at the surveillance network's centralized processing facility and automatically extract attributes or features associated with radar tracks and classify them as well to inform subsequent downstream processing. For example, speed, radar cross section (RCS), track duration/quality and sinuosity (a metric describing the straightness of track trajectory) are useful characteristics to extract as attributes and associate with a track to allow targets of interest (TOIs) to be identified. And track behavior combined with these attributes, along with artificial intelligence (AI) processing and other sensor data (e.g., weather data, camera/video data, RF or acoustic data, et cetera) can all be used to further classify and filter TOIs for subsequent radar data processing. For example, these data can be used to filter out or identify weather tracks, bird tracks and vehicle tracks in order to reduce operator overload, or to ensure that only high-quality general aviation radar tracks are being fed into the multi-radar fusion processor.

A Data UNification Engine (DUNE) in accordance with an embodiment, is yet another specialized radar data processor that would typically run at the surveillance network's centralized processing facility. The DUNE automatically combines all of the surveillance sensor feeds (radar, ADS-B) associated with a surveillance network into a single, unified feed to display in the COP to an RPIC and/or to be used downstream for subsequent data processing as described herein. This unified feed provides great simplification for the RPIC by decluttering the COP display which reduces the information overload that would otherwise result if the collection of sensor feeds was displayed instead. If C-UAS sensors are included in the surveillance network, the DUNE can be configured to include those respective feeds into the unified feed it creates (thereby mixing crewed aircraft with drones in a single feed), or alternatively, a separate unified DUNE feed can be created for these uncrewed and noncooperative drones in the airspace.

To further simplify a situational awareness display in one embodiment, the COP can be configured by each RPIC for each particular mission, by selecting the desired OV and have the COP automatically limit its display to the associated GSV and SV, along with the DUNE feed, with the COP zoomed in to be centered on the OV within the SV, thereby focusing the COP display on the particular mission at hand. Additionally, aircraft tracks in the SV that are at altitudes above the ceiling of the GSV could be greyed out or not shown. In the case of a dynamic GSV, the UAS's location (via GPS or Remote ID) would preferably be used to center the display. For the case of an RPIC flying a one-to-many mission (i.e., a single RPIC is flying two or more UAS' or missions simultaneously), the GSVs selected and displayed would preferably correspond to the two or more UAS missions. And it should be noted that the GSV alerts can be sent directly to the UAS mission system or UTM system so that the UAS(s) can be automatically commanded to maneuver to respective safe position(s) in response to respective intruder alert(s).

The DUNE preferably uses or leverages (i) the aforementioned TAX-TC to filter out unwanted tracks due to weather, birds or vehicles; (ii) multi-radar fusion to fuse and combine radar tracks deemed to be from the same aircraft; and (iii) the MSC to determine which ADS-B and (possibly fused) radar tracks are from the same aircraft, allowing for the separation of cooperative aircraft from noncooperative aircraft in real-time (as radar detects both).

The DUNE is also preferably used to drive the GSV alerts (and SV alerts, if provided as well for early warning) rather than using the individual sensor feeds to test the intruder alerting logic, thereby providing exceptional alert multiplication mitigation as well, in accordance with the teaching above.

FIG. 2 provides a block diagram of an embodiment of a real-time, specialized surveillance data processor 20 incorporating the functionality of the MSC 22, TAX-TC 23, and DUNE 24 processing components. The RFE processing component (not shown) as well as an alert processing component which generates the intruder alerts and noncompliance alerts described herein can be optionally included in data processor 20 or they can run on separate processors. The input to data processor 20 is target track data 21 received from radar and ADS-B sensors associated with a smart surveillance network which can optionally include track feeds from external data sources or services (e.g. FlightAware). Target track data 21 can also optionally include C-UAS track data. For this embodiment, target track data 21 is associated with one or multiple radar sensors and with an ADS-B feed or a composite ADS-B feed. The output of data processor 20 is the DUNE 24 track feed which can be interfaced directly into various C2-type or common operating picture (COP) display software (e.g. ATC software, UTM software, specific vendor display software such as the Accipiter® COP or Kongsberg IRIS) as well as into various post-processors or GIS platforms (e.g. Ersi ArcGIS) including those described hereinafter using interfacing methods and standards known to those skilled in the art (e.g., ASTERIX, JSON, proprietary application programmer interfaces (APIs), et cetera). MSC 22 operates on target track data 21 to identify radar tracks associated with ADS-B tracks and DUNE 24 uses this information to unify respective track updates as discussed earlier. TAX-TC 23 operates on target track data 21 to characterize/classify radar tracks and DUNE 24 uses this TAX-TC 23 information to filter out unwanted targets from making their way into the DUNE 24 unified track feed 25. If an RFE is available and has associated two or more radar tracks and calculated height estimates as taught herein, DUNE 24 will use this information to further refine the DUNE 24 unified track feed.

The present embodiments not only provide specialized real-time radar data processing as described above, but it also exploits short-term and longer-term historical surveillance data to provide specialized, automated SPA of the surveillance system itself, and to characterize the cooperative and non-cooperative traffic in the environment. The specialized SPA methods described hereinafter provide or support a variety of novel functions including:
1. the automated generation of quantifiable measurements characterizing actual (as opposed to simulated or calculated) radar sensor performance;
2. the automated generation of quantifiable measurements characterizing actual (as opposed to simulated or calculated) ADS-B sensor performance;
3. the automated generation of quantifiable measurements characterizing actual (as opposed to simulated or calculated) surveillance network performance;
4. automated surveillance system health monitoring, and alerting to maintenance personnel, RPICs and/or other stakeholders when performance degrades sufficiently, including degradation of radar sensor performance or ADS-B sensor performance;
5. the automated generation of standardized reporting to authorities and stakeholders of the airspace (or waterways in the case of USVs) characterizing non-cooperative and cooperative traffic patterns of interest to RPICs and regulators for risk-based, safety analysis and planning and in support of ensuring the efficacy of safety management systems;
6. certification of portions of the airspace (or waterways) wherein a minimum intruder detection, tracking and/or alerting performance is available to RPICs from an authorized surveillance system service enabling RPICs to conduct uncrewed operations beyond visual line of sight (BVLOS) without visual observers (VOs), within the certified surveillance coverage volumes;
7. certification of portions of the airspace (or waterways) by an authorized surveillance system service wherein the likelihood of encountering an intruder is less than a prescribed, risk-based threshold, enabling RPICs to conduct uncrewed operations (i) with visual observers (VOs), and (ii) beyond visual line of sight (BVLOS) without VOs, within identified and certified surveillance coverage volumes designed to ensure the a priori risk of collision with an intruder aircraft or watercraft is acceptable; and
8. the automated generation of risk assessments of authorized UAS and USV operations in terms of their respective compliance with regulations, for which detected failures could lead to enforcement actions; and the characterization of the respective loss of separation determined in a probabilistic sense between intruder traffic and uncrewed vehicles which could raise safety concerns and provide a leading indicator of increasing risk of air-to-air collisions.

The automated generation of quantifiable measurements characterizing actual radar sensor performance preferably uses the MSC, or the MSC in combination with the DUNE. Actual radar sensor performance could be measured quantifiably by flying a test target such as a small general aviation aircraft through a series of way points designed to be within the surveillance coverage volume of the particular radar sensor while observing where good radar tracks are formed. These radar tracks, consisting of a series of track updates or measurements, could then be used to determine radar performance metrics such as minimum tracking range and maximum tracking range for a particular target type; and to characterize the locations of LOS obstructions in the field of view, and the effective beam pattern and coverage volume in three dimensions. This classical testing process is expensive and time consuming because flying aircraft is expensive, the beam coverage volume is typically very large, and analyzing the track data is labor intensive. We recognize that many commercial and general aviation aircraft carrying ADS-B are flying within and through the surveillance coverage volume (i.e., they enter and exit) all the time; and over the duration of say a few days or so, the beam coverage volume will largely or at least significantly be sampled with such aircraft test-targets of opportunity, even in Class G airspace, to provide meaningful test data. An embodiment processes these radar and ADS-B sensor data, using the specialized MSC and DUNE processing as further described below, to automatically generate actual radar sensor performance data.

The MSC may be used to automatically correlate and determine which respective radar tracks are associated with which aircraft of opportunity that are carrying ADS-B that serves as a test target. In this way, the MSC provides the means to automatically gather or create a collection of track pairs, i.e., a radar track and corresponding ADS-B track, associated with a particular aircraft and aircraft type (the aircraft type can preferably be automatically looked up using the ADS-B track identifier in one embodiment). The ADS-B information contained in each track pair provides the ground-truth information (similar to hiring a test pilot/aircraft to fly a particular set of way points confirmed by onboard GPS) including a trajectory fully resolved as a sequence of {latitude, longitude, altitude} location coordinates. A scatter plot of these coordinates from all track pairs over the data collection period provides an effective means of characterizing the actual beam pattern and surveillance coverage volume. The corresponding radar track information provides the actual evidence of radar performance, including slant-range, location coordinates (may only have {latitude, longitude} with 2D radars), radar track quality, RCS, velocity and other parameters. Automatically deriving statistics or metrics from this radar track information over the collection period provides actual radar performance data such as maximum detection or tracking range for a particular aircraft type, or the 70^{th} percentile maximum range (e.g., the radar tracks this type of aircraft 70% of the time from/to a distance of 10 km).

While the MSC provides the specialized SPA processing for a particular radar sensor, using the DUNE extends this radar performance functionality to a multi-radar surveillance network. Radar track and ADS-B track pairs are formed in an analogous and automated fashion using the DUNE feed instead of an individual radar sensor feed and ADS-B sensor feed. The CRSV performance can be assessed as can the respective performance of the individual radar surveillance volumes, by having the DUNE maintain the relationships between the DUNE feed and the contributing radar and ADS-B feeds. In other words, the DUNE preferably maintains and stores the relationships that define which sensors are contributing to each DUNE track update (as determined through correlation, association, integration and fusion as further described herein) at a particular time, so that post-processing can be performed on the fly (real-time) or subsequently using historical data with the specialized SPA methods and processors described herein.

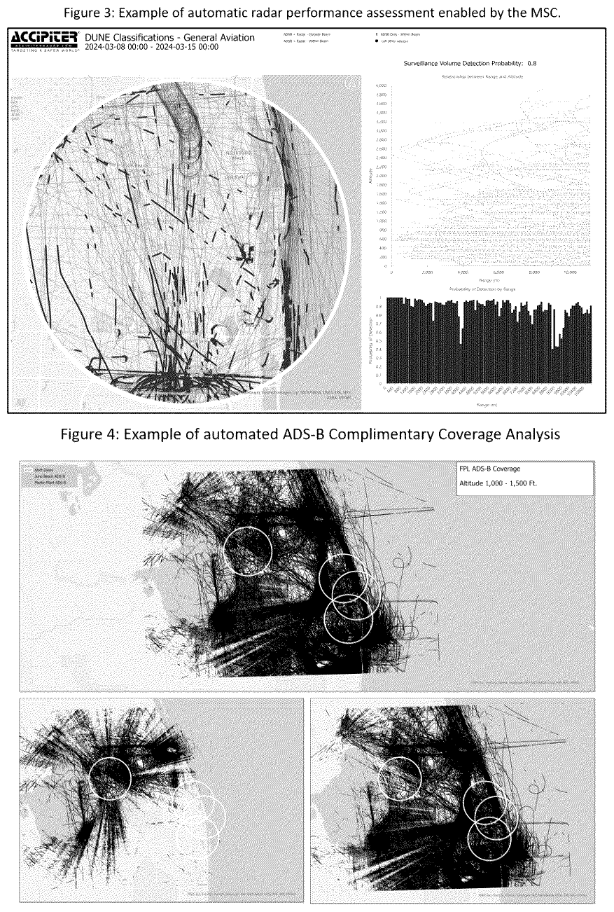

FIG. 3 is an example of an automatically generated radar system performance assessment enabled by the MSC in conjunction with the DUNE as described above, using real radar and ADS-B track data for a data collection period of one week and for a single radar. The example SPA process selects only the general aviation aircraft tracks for that period to process, and filters them to remove any ADS-B track updates outside of the elevation beam pattern of the 2D radar and the SV denoted by the circle in the image on the left, thus creating a set of ADS-B tracks to be used as ground-truth test targets for assessing the radar's performance. For each ground-truth test target track update, if the MSC had correlated a radar track with it, the associated general aviation aircraft would be deemed to have been “detected” (and tracked) by the radar for that update. The radar is located at the center of the image. The thin, light lines in the image on the left indicate all of the successful detections by the radar. The thicker, dark line points/segments denote the missed detections by the radar. At a glance, we can see that the radar is successfully detecting and tracking the general aviation aircraft (only the smallest ones were selected for this SPA) throughout the surveillance volume out to the maximum SV range as expected. These SPA data are further analyzed statistically and geometrically by the SPA process generating the two figures on the right. The lower figure shows a probability of detection versus range distribution, calculated by grouping the ground-truth test target updates into range bins going out from the radar to 11 km (the limit of the SV); and for each range bin, calculating the ratio of “detected” target updates to the total number of target updates in that range bin. The total probability of “detection” (more accurately the probability of the radar successfully tracking the ground-truth test targets throughout the SV) is shown above the upper figure on the right to be 0.8 (i.e. 80% for this example). The upper figure provides a vertical or elevation cross-sectional scatter plot of the ground-truth test targets input into the SPA process. It plots altitude to 4,000′ above ground level and illustrates a target rich environment with many general aviation aircraft at low altitudes. One of the reasons why detection probability drops at certain ranges is because these low altitudes are blocked by LOS obstructions as discussed earlier. The actual quantifiable measures shown in FIG. 3 (spatial image of detections/missed-detections, probability of detection versus range, and total probability of detection) are just a few of the many measures known to those skilled in the art which we could use for SPA purposes in accordance with this disclosure. These quantifiable measures could be used to establish a radar performance baseline for the week of Mar. 8-15, 2024 (the dates these data were collected), and then recalculated (weekly for example) with significant deviations from the baseline triggering alerts of degraded performance. For example, if the total probability of detection dropped by 5% to 75%, an alert could be triggered. Or if any new range bin probability was reduced by more than 50% of its baseline value, an alert could be triggered. These system health alerts would cause technical personnel to examine the performance closely and determine what corrective actions are needed to restore performance to the baseline.

SPA also applies to ADS-B sensors as they too can degrade and fail. The automated generation of quantifiable measurements characterizing actual ADS-B sensor performance, preferably uses a specialized ADS-B data processor that unifies or combines data from multiple ADS-B sensors or ADS-B data sources while maintaining and storing the relationships that define which ADS-B sensor(s)/source(s) have contributed to each update of the ADS-B data processor output. Flying a test aircraft which broadcasts ADS-B as described above can be used to test the actual performance of a particular ADS-B receiver, but this is expensive for the same reasons described above with respect to radar testing. In fact, due to the very large distances associated with ADS-B reception (200 km or more), this would likely be prohibitively expensive. Rather, we prefer a differential analysis which uses two or more ADS-B sensors (i.e., receivers deployed at different locations) or one ADS-B sensor (the sensor under test) and a third-party ADS-B service such as FlightAware to provide a second ADS-B data source that would support the differential analysis. For the case of N ADS-B sensors (N>2), pair-wise differential analysis is carried out with any or all unique combinations. For each aircraft of opportunity broadcasting ADS-B over the collection period, the specialized ADS-B data processor will generate three ADS-B reception maps structured identically by dividing up the composite ADS-B surveillance volume into voxels (i.e., three dimensional cells). For example, Universal Transverse Mercator coordinates could be used covering a horizontal and vertical distance on the earth's surface each spanning 200 km using a 1 km×1 km grid spacing, coupled with 100′ altitude spacing from ground level to 5,000′ AGL. In this example, each voxel would represent a 1 km×1 km×100′ sub-volume, with 200×200×50 voxels representing each of the three ADS-B reception maps. The differential analysis uses the first ADS-B reception map to indicate the number of ADS-B measurements or updates received in each voxel by the first ADS-B receiver, the second ADS-B reception map tabulates the same information for the second ADS-B receiver or service, and the third ADS-B reception map is a joint map that represents the number of ADS-B broadcast messages received simultaneously by both ADS-B sensors (or sensor/source, or both sources, as the case may be) in the differential pair.

The differential analysis carried out by the specialized ADS-B data processor involves analyzing independently the first two individual ADS-B reception maps to determine respective metrics such as maximum reception range for each, and analyzing that data as a function of direction (0 to 360 degrees) and/or altitude, for example. Additionally, metrics can be established around selecting a number of specific cooperative aircraft that frequent the area and determining a minimum number of expected pings to expected to be received for the selected period. This particular metric can also be used to detect a failed ADS-B transmitter on a particular aircraft in addition to a degraded ADS-B receiver. Each map and its associated metrics speaks to the basic performance of its respective receiver. The joint ADS-B reception map represents the combined coverage of the pair of ADS-B sensors. Analyzing this map is useful for determining LOS obstructions or radio shadows (analogous to radar shadows). Comparing this joint reception map with each of the independent reception maps provides an immediate sense of the redundancy or complimentary nature afforded by each of the two ADS-B sensors. If the joint map and the individual maps are virtually identical in the composite surveillance volume of interest, then the ADS-B sensors are primarily providing redundancy. If, however, an individual map differs significantly from the joint map, that means the two individual ADS-B sensors are providing significant complimentary coverage. Comparing the two independent ADS-B reception maps provides a more direct comparison between the two ADS-B sensors and can quickly identify that one sensor is working much better than the other by virtue of the greater reception it provides of ADS-B broadcasts from aircraft of opportunity. The comparing of pairs of reception maps is easily performed by the specialized ADS-B data. For example, normalized differences (subtraction) can be carried out voxel by voxel, binned in any dimension (e.g., examine performance for altitudes below 500′ AGL versus above 500′ AGL) and summed, averaged, and/or represented as an ordered statistic to allow for straightforward and quantifiable comparisons.

FIG. 4 is an example of an automatically generated ADS-B complimentary coverage analysis which is one simplified type of quantifiable measure of ADS-B sensor performance, namely a set of spatial reception maps using in this example a 500′ voxel separation and displaying actual ADS-B pings or track updates, instead of ping counts in each voxel. This representation is more suitable for teaching purposes when the use of color in representing data is not an option. This differential analysis involves two ADS-B receivers. Since aircraft are more easily seen at higher altitudes than at lower altitudes due to LOS obstructions in the way of a receiver, the differential analysis is divided into different altitude bands, 500′ bands in this example. Only the 1000′ to 1500′ altitude band is shown in FIG. 4. If a 1000-foot vertical separation is desired for alerting purposes, this altitude band is of particular significance for all low-flying drone operations. Alert zone circles are also illustrated representing notional, horizontal, intruder alert boundaries. If an intruder is detected flying into an alert zone, drone operations underway therein would go to a safe position. ADS-B receiver-1 is located at the center of the alert circle shown in the lower left image. ADS-B receiver-2 is located at the center of the middle alert circle shown in the lower-right image. The lower left image shows clearly that ADS-B receiver-1 provides good aircraft coverage for its alert circle but provides virtually no coverage of the three alert circles shown in the lower-right image. On the other hand, ADS-B receiver-2 provides good aircraft coverage of the three alert circles shown in the lower right image but provides a relatively small amount of coverage for the alert circle shown in the lower left image. It can be said that this pair of receivers provide mostly complimentary coverage in the areas associated with their respective alert circles. It can also be seen that redundant coverage is provided by the pair of receivers for higher latitudes than the latitude of ADS-B receiver-1, i.e. in areas to the north. It can also be seen that there are a number of small radial sectors emanating out from ADS-B receiver-1 (to the south for example) and ADS-B receiver-2 (to the southwest for example) where coverage is absent or extremely limited due to LOS obstructions resulting in RF shadows in the respective images. Here we see that ADS-B, often presumed by users (due to its ease of interpretation and completeness of target information as a cooperative sensor) to be a perfect source of ADS-B air traffic, behaves like radar when it comes to propagation physics and has areas where it is blind and will not see the air traffic. The upper image in FIG. 4 illustrates the combined coverage of the pair of ADS-B receivers. While most of the southerly RF shadows of ADS-B receiver-1 have been filled by ADS-B receiver-2, the ADS-B receiver-2 southwesterly shadows largely remain. What is important is to establish appropriate ADS-B performance baseline data for all relevant alert zones associated with drone operations.

With actual baseline sensor performance data established as described above, for example during commissioning of a new sensor or annual recommissioning of an existing sensor or following maintenance, automated surveillance-system performance health monitoring can now be carried out periodically (e.g., once a week, once a day, once an hour) through differential analysis (similar to that described above in relation to ADS-B reception maps) between the established baseline performance data and the current sensor performance data (i.e., using the most recent sensor data with a rolling window into the past using historical data). If the actual current performance is degraded materially from the established baseline, automated alerts can be provided to maintenance personnel, RPICs and/or other stakeholders so they can investigate further and take corrective action, and so they can alter their BVLOS operations accordingly to ensure safety.

Because of the unique integration between the MSC and DUNE, another approach exists for detecting ADS-B failures and alerting using changes in quantifiable measures. When an ADS-B sensor fails or degrades, the MSC correlation will naturally be reduced and the DUNE will starting outputting many more uncorrelated tracks, suggesting an increased air risk with uncooperative aircraft. If the ADS-B receiver performance degraded in a particular direction, then the increase in uncorrelated tracks over the baseline will be localized, providing an important clue towards the root cause.

With confidence that the BVLOS surveillance system is performing correctly, automated standardized reporting which characterizes noncooperative and cooperative traffic patterns of interest can be generated and provided to authorities and stakeholders periodically for better understanding of the hazard environment and the risk posed in relation to BVLOS operations, as well as for identifying changes in traffic patterns and risk over time. The MSC and DUNE have a particular role to play here, as they enable the automated differentiation between noncooperative and cooperative traffic when used with surveillance networks including both radar sensor(s) and ADS-B sensor(s). The DUNE allows for the efficient segregating of the traffic into four categories which serve various SPA methods and objectives described hereinafter and incorporated into reporting features: (i) radar tracks from aircraft that are not squawking ADS-B (i.e., noncooperative aircraft); (ii) cooperative ADS-B tracks from aircraft within the CSCV that were also tracked by radar (as determined by the MSC); (iii) cooperative ADS-B tracks from aircraft within the radar CSCV that were not tracked by radar; and (iv) cooperative ADS-B tracks from aircraft outside of the radar CSCV for which radar tracks are not expected. Category (i) tracks can be used to characterize noncooperative traffic and Category (ii), (iii), and (iv) tracks can be used to characterize cooperative traffic. The standardized reporting is preferably generated from historical DUNE data either on an as requested basis, or on a regular schedule such as daily, weekly, monthly, or annual basis. The generated reports can be based on any amount of historical data, but typically would align with the reporting frequency. For example, a daily report would use the last day's worth of data, a weekly report would use the last week's worth of data, and so on.

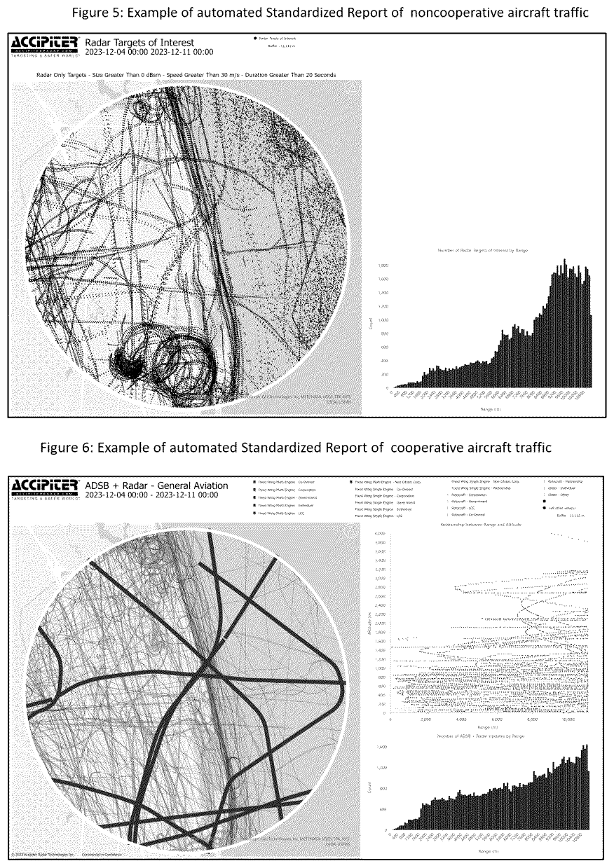

One standardized reporting method may use Category (i) tracks to characterize the presence of noncooperative aircraft in the airspace which pose an air-to-air collision hazard with other aircraft including drones. Even in Class G airspace, a weekly report can generate a sufficient number of noncooperative aircraft tracks to sample, or cover in extent, the whole surveillance volume associated with a medium range radar. In other words, if VOs were positioned appropriately so they could view the entire overhead sky throughout the SV, every VO would likely encounter one or more noncooperative aircraft over the course of the week. Hence, if VOs are not required for BVLOS operations with drones, an air-to-air collision is indeed possible and characterizing the hazard and risk with regular standardized reporting is meaningful for all involved in ensure safe operations. The standardized report could present an automated analysis of the noncooperative aircraft traffic in many ways. A preference for easily and quickly presenting the hazard and risk to stakeholders includes one of more of the following information components in the standardized report:
a. A track histories view showing the individual tracks overlaid on a street-type or satellite-image-type, earth-based map. A glance at this component shows where the noncooperative aircraft traffic is occurring in space and where traffic is sparse or dense, and the nature of the tracks (e.g., circling or transit) provides an indication of the type of operations being flown, especially in relation to nearby aerodromes (this is illustrated in FIG. 5 on the left side);
b. A chart that plots the number of tracks (or percentage of tracks) versus time of day (24 hours) showing dusk and dawn markers to differentiate with a glance daytime flying and nighttime flying;
c. A chart that plots the number of tracks (or percentage of tracks) versus day of week, making it easy to identify weekends and holidays;
d. A chart that plots the number of tracks (or percentage of tracks) as a function of range or azimuth (this is illustrated in FIG. 5 on the right side);
e. A chart that plots the altitude distribution or the altitude versus range distribution (if a 3D radar is used) of the radar tracks;
f. One or more charts that quantitatively compare high traffic rates and low traffic rates to make it easy to identify times and locations to avoid drone operations, or times and locations to conduct drone operations in order to minimize risk. For example, temporal and/or spatial aircraft encounter rate thresholds could be defined (using standardized thresholds set by regulators or safety bodies, thresholds based on large volumes of actual traffic data, or arbitrary thresholds geared to specific drone operations or applications), and then applied to the track data to determine times of day and/or locations where these thresholds are exceeded. A 1 km by 1 km spatial cell and an hourly temporal cell could be used, for example, to calculate the aircraft encounter rate per km², per hour, or per km²-hour; and
g. Charts that present the rate or likelihood of encountering noncooperative aircraft within the OVs or GSVs of authorized drone operations, achieved by filtering the track data to those that intersect respective OVs or GSVs.

FIG. 5 illustrates an example of an automatically generated standardized report of noncooperative aircraft traffic for a particular surveillance volume using a number of 2D radars with overlapping coverage. The spatial image shows the noncooperative radar traffic for a one week period with a little more than half of the surveillance volume over land and the remainder over water. The circular track behavior shown in the southern part and the northern part of the image are often observed with noncooperative targets. A closer look at some of the longer tracks in the image reveals what appears to be two or three aircraft flying. These in fact are likely from the same aircraft that is being tracked by two or three radars with overlapping coverage. In other words, multiple radar are providing some redundant coverage within the illustrated SV. As 2D radars are doing the tracking here, altitude is not available so the ground track calculation for the same target from each radar can be different because of the assumed mapping from slant-range to ground-range. If multi-radar fusion is employed which is discussed elsewhere herein, these duplicate and triplicate tracks for the same noncooperative target can be associated together and the DUNE would preferably replace them with a single fused track, thereby automatically removing the multiplicity for noncooperative targets. Looking closely over the water, it is easy to see that several short tracks are due to sea clutter. If the TAX-TC were employed to automatically classify these tracks as sea clutter tracks, they would be filtered out by the DUNE. The count versus range chart included in FIG. 5 shows us that the traffic pattern captured by the DUNE feed, which has the number of targets increasing with range. If both multi-radar fusion and TAX-TC were employed, the resulting count versus range chart would better reflect the true count distribution of noncooperative aircraft in this SV.

It should be noted that the above components can be generated for surveillance networks which do not include ADS-B sensors but the processors won't be able to automatically differentiate between radar tracks from noncooperative versus cooperative targets.

Another standardized reporting method uses Category (ii), (iii) and (iv) tracks to characterize the presence of cooperative aircraft in the airspace which pose an air-to-air collision hazard with other aircraft in the vicinity including drones. The standardized report could present an automated analysis of the cooperative aircraft traffic, namely the union of the Category (ii), (iii) and (iv) tracks (and which does not require any radar sensors), in many ways; and could be automatically generated for any duration of time (e.g., hourly, daily, weekly, monthly, annually) and updated on any frequency or dates/times or upon request so that they could be used for a variety of purposes. Presenting the hazard and risk to stakeholders includes one of more of the following information components in the standardized report:
a. A track histories view showing the individual cooperative tracks overlaid on a street-type or satellite-image-type, earth-based map. A glance at this component shows where the cooperative aircraft traffic is occurring in space and where traffic is sparse or dense, and the nature of the tracks (e.g., circling or transit) provides an indication of the type of operations being flown, especially in relation to nearby aerodromes (this is illustrated in FIG. 6 on the left side);
b. A chart that plots the number of tracks (or percentage of tracks) versus time of day (24 hours) showing dusk and dawn markers to differentiate with a glance daytime flying and nighttime flying;
c. A chart that plots the number of tracks (or percentage of tracks) versus day of week, making it easy to identify weekends and holidays;
d. A chart that plots the number of tracks (or percentage of tracks) as a function of range or azimuth (this is illustrated in FIG. 6 on the lower right side);
e. A chart that plots the altitude distribution or the altitude versus range distribution of the cooperative tracks (this is illustrated in FIG. 6 on the upper right side);
f. One or more charts that quantitatively compare high traffic rates and low traffic rates to make it easy to identify times and locations to avoid drone operations, or times and locations to conduct drone operations in order to minimize risk. For example, temporal and/or spatial aircraft encounter rate thresholds could be defined (using standardized thresholds set by regulators or safety bodies, thresholds based on large volumes of actual traffic data, or arbitrary thresholds geared to specific drone operations or applications), and then applied to the track data to determine times of day and/or locations where these thresholds are exceeded. A 1 km by 1 km spatial cell and an hourly temporal cell could be used, for example, to calculate the cooperative aircraft encounter rate per km², per hour, or per km²-hour;
g. Charts that present the rate or likelihood of encountering cooperative aircraft within the OVs or GSVs of authorized drone operations, achieved by filtering the track data to those that intersect respective OVs or GSVs;
h. Any of the above components filtered by aircraft type (e.g., fixed wing, rotary, commercial, general aviation, model), departure airport, destination airport, airline, aircraft identifier, et cetera) (see FIG. 6 for an example of this); and
i. Any of the above components derived for Category (ii), Category (iii) or Category (iv) tracks individually, or in combination e.g., Category (ii)+Category (iii) tracks represent cooperative aircraft of opportunity that are expected to be seen by radar if present and can be used to confirm sufficient test targets of opportunity are available for automated SPA.

FIG. 6 shows an example of this automated, standardized report of cooperative aircraft traffic which serves as a risk assessment as well as identifying the availability of radar test targets of opportunity. FIG. 6 illustrates cooperative aircraft traffic for the same surveillance and one week period associated with FIG. 5. Since altitude information is available with ADS-B, an altitude versus range distribution is provided in the upper right of the report, in addition to the number of cooperative aircraft versus range chart in the lower right of the report. Examining the track histories or spatial map, we can learn much about the local traffic pattern. For example, the larger, multi-engine fixed wing aircraft are denoted by thick black tracks and they are relatively few in number in this airspace. The rotocraft are shown as the thicker grey lines while the single-engine fixed wing aircraft are shown as thinner grey lines. Both aircraft types fly over land and water, although most of the traffic is over land. The majority of the traffic 1,000′ altitude and below are flying approximately level flight across the region, while above 1,000′ altitude, more aircraft are observed climbing and descending.

Sophisticated surveillance system health monitoring can be based on any combination of the radar, ADS-B or surveillance network quantifiable measures or information components described above and calculated as frequently as hourly, with automated alerting provided to maintenance personnel, RPICs and/or other stakeholders when evidence indicates that radar and/or ADS-B performance may have degraded below an acceptable threshold. The evidence may be automatically calculated by comparing the current quantifiable measure or information component against the expected values or baseline and testing for significant differences. System health indicators can be provided directly in the COP, or in a separate application, with audio notifications to grab the RPICs attention and indicator color changes (e.g., from green for healthy to red for degraded performance). System health data is logged for use in incident investigations and training.

Since most RF (radar and radio) receiving sensors include solid-state processing and storage today, their performance can degrade in subtle ways, like a computer that starts to slow down by design or behave weirdly because it is overheating, and then be seemingly restored as soon as the excess heat is dissipated. With the effects of climate change and El Niño, hot temperatures are also being experienced in the environment more and more, and temperature throttling circuits can slow down or shutdown surveillance sensors. Unseen damage in these remote sensors can occur which reduces their performance. The impact of this undetected damage is a degradation in sensor performance that may only be observable by a reduced number of aircraft detected and hence a reduced number of tracks. This type of degradation may result in detecting lower aircraft traffic densities in standardized monthly reports for after the degradation as compared to prior, as well as traffic reductions in year over year. While the sensors may appeared to be working fine after degradation, they may actually operating at reduced performance levels which could have negatively impacted safety and security. Sophisticated surveillance system health monitoring, including differential comparisons of traffic patterns month to month and year over year, may be used to identify anomalies that may be indicative of degraded sensor performance, leading to further investigation and maintenance. Automated alerts sent to maintenance personnel based on these differential comparisons exceeding defined thresholds ensure that subtle degradation in surveillance system health can be responded to quickly to restore system performance to baseline conditions.

An authorized surveillance system service may certify portions of the airspace (or waterways) where a minimum intruder detection, tracking and/or alerting performance is available enabling RPICs to conduct uncrewed operations beyond visual line of sight (BVLOS) without visual observers (VOs), within the certified surveillance coverage volume(s). In addition to certifying the airspace, which is a flight planning or mission planning function, the authorized surveillance system service can also provide the real-time detect and alert data to ensure each registered RPIC user has the real-time intruder awareness needed to fly their drone safely for their mission. The certified coverage volume(s) are one or more regions of airspace where the RPIC is assured that the surveillance system service will provide real-time alerts to the RPIC when an intruder aircraft appears in the certified volume(s). The surveillance system service is supported by a surveillance network that uses various quantifiable measures and/or information components described above coupled with the above surveillance health monitoring and alerting when performance degrades, in order to identify those regions of the airspace where intruder detection and alerting meets the minimum performance requirements or standards set by the appropriate authorities. Each certified region of airspace is defined by its horizontal or surface extent on the earth's surface, typically represented as a geofence of arbitrary shape, coupled with altitude limits (altitude floor and altitude ceiling) which may be uniform across the surface extent or which may vary. For a certified region of airspace of interest to a particular RPIC and drone operation, it is the RPIC's responsibility (or possibly the UTM service provider in the case where the surveillance system service is integrated into a broader UTM service structured to take on this responsibility) to determine an appropriate OV within which to operate that is situated well within the certified region of airspace to ensure that intruder notifications, tracks, or alerts will be received from the service early enough to provide the RPIC with sufficient time to decide on a safe maneuver (if required) and to command the drone and provide the particular drone with sufficient time to get into a safe position and remain well clear of any approaching or passing intruder aircraft. The surveillance system service could be a backend detect and alert service included with a particular UTM service, a private surveillance service or a public cloud subscription surveillance service that any RPIC can register for and subscribe to directly for real-time intruder detect and alert data in order to facilitate safe drone operations. The authorized surveillance system service would preferably publish maps indicating where certified coverage volumes exist, automatically removing affected regions when the surveillance system health monitoring indicates possible degradation in system performance. Another mode for the service involves the RPIC uploading or specifying its proposed OV along with parameters such as RPIC response time, drone maneuver descent speed, horizontal speed, and go safe location(s). The service uses this information to determine the time budget needed for the drone to maneuver to a safe location following an intruder alert, and the associated GSV is then determined given the OV and time budget. The service then determines whether the required GSV is fully within a certified volume, notifying the RPIC of the same. The authorized surveillance system service could also be integrated with or directly used by RPIC mission software to receive intruder tracks (and/or alerts) in real-time and also provide its own alerting to the RPIC, including for dynamic GSVs.

Another authorized surveillance system service similar to the one described above certifies portions of the airspace (or waterways) where the likelihood of encountering an intruder is less than a prescribed, risk-based threshold, enabling RPICs to conduct uncrewed operations (i) with visual observers (VOs), and (ii) beyond visual line of sight (BVLOS) without VOs, within respective identified and certified surveillance coverage volumes designed to ensure the respective a priori risk of collision with an intruder aircraft or watercraft is acceptable. For such cases, the historical traffic patterns of cooperative and noncooperative aircraft (which can include uncrewed aircraft) using Category (i), (ii), (iii) and (iv) tracks described earlier and updated regularly (even hourly on a scrolling time basis) are used to characterize the spatial/temporal likelihood of aircraft presence and test that this likelihood is less than a respective prescribed threshold in order to certify each respective volume of concern. Knowing that the risk of encountering an intruder for particular proposed drone mission(s) in particular location(s) is an enabler for regulators to allow specific types of drone flights by a specific rule or exemption of a rule, or application of a waiver. This certified-airspace-with-low-risk-of-intruder-encounter knowledge allows novel concepts such as the right-of-way granted to drones instead of crewed aircraft for flying specific flight patterns (e.g., shielded flights over infrastructure such as power lines) to be safely considered, tested, authorized, and then monitored on an ongoing basis by stakeholders. With crewed general aviation aircraft, VFR in Class G airspace has been sufficient for decades for aviation safety, not requiring ADS-B on aircraft and air traffic controllers. With uncrewed drones, there must be additional, risk-based assessments of the air space to define where drones can fly (and USV's can operate) BVLOS with a low probability of encountering crewed aircraft, which the proposed methods can help define and assure.

Finally, the automated generation of risk assessments of authorized UAS (or USV) operations in terms of their respective compliance with regulations, is provided by analyzing the actual UAS (or USV) tracks (generated from GPS directly or received through Remote ID or from a UTM system) along with the historical noncooperative and cooperative aircraft (or vessel) tracks generated using the specialized methods and processing taught above. As described earlier, the DUNE can be used to unify UAS (or USV) tracks making these automated risk assessments even more practical. The UAS tracks are compared automatically against their authorized OVs and detected failures associated with flying outside of their OVs could lead to enforcement actions. Furthermore, the automatically generated risk assessments can also characterize the respective loss of separation determined in a probabilistic sense between intruder traffic and uncrewed vehicles which could raise safety concerns and provide a leading indicator of increasing risk of air-to-air collisions. As a function of time, the closest distance between a particular UAS and the surrounding aircraft can also be automatically measured, stored and/or processed to provide this novel risk assessment, all with a view of reducing the likelihood of near misses (and therefore collisions), where the particular UAS and surrounding crewed and uncrewed aircraft are not too close to the same location at the same time.

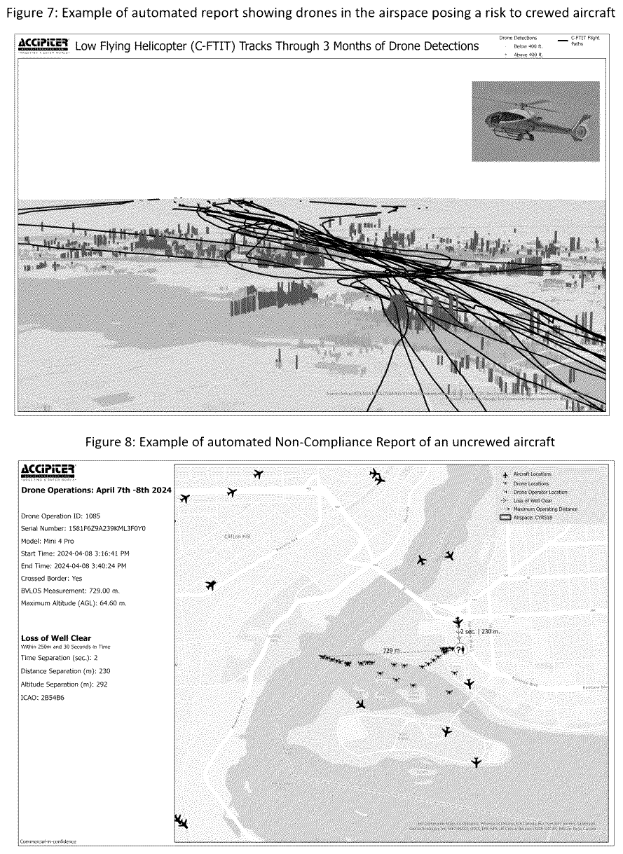

FIG. 7 is an example of an automated risk assessment report calculated over a 90-day time period visually showing drone risk posed in an airspace of interest to a particular, low-flying rotary aircraft. The collection of the nominally horizontal black tracks are those of the subject helicopter over this 90-day period derived from ADS-B tracks accessed in accordance with this disclosure. The clueless and careless drones over the same 90-day period are shown using vertical lines derived from a C-UAS tracks accessed in accordance with this disclosure. Each darker grey line represents a drone operation of a drone that flew above the regulated 400′ ceiling, with the height of the line representing the maximum height flown by the drone during its operation and the location of the line representing the latitude, longitude of the drone when its maximum height was measured. Each lighter grey line similar represents a drone operation for a drone that stayed within the 400′ regulated ceiling. The first startling observation is that unregulated drones are everywhere; and the second startling observation is that many of them are flying above the regulated 400′ ceiling. FIG. 7 is taken in the immediate vicinity of a large international airport (YUL) making the drone violations particularly concerning. The risk of collision is all too clear as illustrated in the lower right of the image where the helicopter tracks fly through the same region of airspace that drones are violating. It is just a matter of luck that a collision hasn't already happened and a matter of time before they do happen at greater frequency. Helicopter pilots can barely see the drones as they fly through the airspace. By providing a user-centric display of drones immediately in the path of crewed helicopters, we can help them see and avoid drones. An example of this user-centric display technology is described in U.S. patent Ser. No. 11/828,945B2 where birds there are substituted by drones here, which are essentially hard birds. Not surprisingly, drones are often attached by predator birds due to their obvious similarities.

FIG. 8 is an example of an automatically generated non-compliance report for a particular UA operation, generated during the Eclipse at Niagara Falls on Apr. 8, 2024, where the drone pilot flew dangerously in the dark, crossing an international border in restricted airspace, flying beyond visual line of sight and resulting in a near-miss with aircraft. Looking at FIG. 8, the drone pilot is denoted by white circle containing a black question mark symbol next to a black person symbol. The drone locations during the particular drone operation with ID: 1085 are shown by a drone symbol drawn at each track update as provide by a C-UAS sensor. The drone serial number, model and the start and stop time and date of the drone operation are also reported. ADS-B aircraft track updates are also shown for aircraft in the vicinity during the drone operation. The drone pilot is 729 m away from the furthest drone track update which is beyond visual line of sight by any standard. The fact that the drone crossed the international US/Canada border is also clear. And at the closet point of approach between the aircraft in question (ICAO: 2B54B6) and the drone, only 230 m horizontally and 292 m in altitude separated them representing a loss of separation that is deemed too close for comfort (less than 250 m in the example).

The specialized real-time radar and other surveillance sensor data processing along with the specialized short-term and longer-term historical surveillance data processing described above which provide situational awareness, alerting, characterization of cooperative and noncooperative aircraft (and vessel) traffic in the environment in support of uncrewed BVLOS operations and sophisticated surveillance system health monitoring, are also applicable in an analogous fashion to (i) unmanned traffic management (UTM) applications, where we want to keep uncrewed aircraft well separated from each other, especially as more drones are authorized to fly in designated airspace, and (ii) in C-UAS (Counter—Unmanned Aircraft System) applications, where we want to ensure that drones do not pose a security risk to facilities or other drone users such as a drones as first responder (DFRs). For the UTM and C-UAS applications, the collection of drones operating in an airspace takes the place of the cooperative and noncooperative aircraft described above. For the UTM application, each UTM-registered drone will consider all of the other drones in the airspace as the aircraft to avoid and keep well separated from. For the C-UAS application, all drones in the airspace will be of interest for threat awareness and threat assessment. The surveillance network sensors in these two applications include radar (that is capable of tracking drones), Remote ID receivers and real-time drone location data (based on local GPS) communicated directly from drone management software, the UTM software application for registered drones or another authorized service provider (these “cooperative sensors” take the place of ADS-B), and C-UAS sensors such as RF receivers. In the C-UAS application where a criminal drone could be intent on interfering with law enforcement, a public event, emergency management operations, or inflicting damage or a serious security breach on a facility (e.g., nuclear plant, data center, airport, prison), the intruder DAA capability and the specialized health monitoring described earlier is of added importance, as unlike aviation safety applications, criminal drones will not follow the rules. Intruder alerts need to be responded to immediately, and if the surveillance system is degraded, immediate corrective action may be required. This would be true even in the case of redundant systems. The MSC processing can be applied to the radar/C-UAS sensor track data on the one hand and the “cooperative sensor” track data on the other, and the DUNE processing can be applied to all of the sensor data.

The present description teaches novel improvements in radar and sensor data processing systems as enumerated and described above, directed especially to large-scale operations involving uncrewed vehicles including drones and vessels and could also be extended in the future to automobiles, which is new for society. It describes major improvements for air traffic management, UTM and vessel traffic management processes where looking forward with uncrewed vehicles, the human controllers are no longer located in the immediate vicinity of the traffic they have to manage. The improvements arise from the automated and specialized radar, ADS-B and C-UAS data processors and post-processing methods which operate on sensor track data provided by a surveillance network or service and which can differentiate between cooperative and noncooperative targets.

Several key embodiments are now described which combine the various teachings provided herein to deliver key improvements in various safety and security applications.

A first key embodiment is a smart, real-time radar data processing system for assisting remote pilots in command of uncrewed vehicles beyond their visual line of sight to avoid collisions with other crewed or uncrewed vehicles in their vicinity where said vehicles are aircraft, vessels or automobiles, comprising:
1. a track data interface configured to receive continuously in real-time target track data from a surveillance network and making said target track data available for subsequent data processing, said target track data originating from at least two sensors associated with said surveillance network with each of said sensors generating a respective track data stream and said track data streams collectively making up said target track data, said sensors taken from the group of radar, cameras, C-UAS receivers, ADS-B receivers, RemoteID receivers, and AIS receivers, said ADS-B, RemoteID and AIS receivers generating target track data from cooperative targets in the environment taken from the group of crewed and uncrewed aircraft, vessels and automobiles, and who broadcast their respective identity and precise location regularly over time, and said radar, cameras and C-UAS receivers generating target track data from the group of noncooperative targets, cooperative targets, and clutter generating phenomenon in the environment, said clutter generating phenomenon taken from the group of birds, precipitation and surface features such as trees and ocean waves, said noncooperative targets not actively participating in being identified and precisely located in the environment over time, said noncooperative targets also taken from the group of crewed and uncrewed aircraft, vessels and automobiles, each said track data stream providing a continuous stream of track updates from said cooperative targets, noncooperative targets and clutter generating phenomenon tracked by said surveillance network and sent to said track data interface, each respective said track update including a track identifier, date/time stamp, and location information associated with said respective target or said respective clutter generating phenomenon, said target track data thereby including a multiplicity of seemingly unique target tracks which are in fact associated with the same physical target that is active in the environment, said multiplicity increasing as the number of said sensors with overlapping coverage in said surveillance network grows and as the number of active targets in the environment grows, making said target track data more and more confounding to interpret;
2. a surveillance data processor operatively connected to said track data interface and configured to receive said target track data from said track data interface in real-time;
3. said surveillance data processor further configured to automatically process said received target track data in real-time by unifying the collection of said respective track data streams contained in said received target track data into a single unified track feed, said unified track feed representing each said active target with a unique, unified target identifier, and each track update associated with said unified target identifier including a unified target date/time stamp and unified target location information which update continuously over time, said unified track feed generated by said surveillance data processor by the automatic (i) determination of the said multiplicity of unique tracks associated with each physical target using multi-sensor processing algorithms taken from the group of cross-correlation algorithms and fusion algorithms on a time update by time update basis to identify those track updates from said received target track data which are associated with the same target, and (ii) combining or joining of said associated track updates in order to form each unified track feed update by extracting and assembling the best target location information available from the said associated track updates;
4. said surveillance data processor further configured to automatically process said unified track feed by performing additional integration, filtering or enhancement functions whose purpose is to improve said unified track feed data quality;
5. and said surveillance data processor further configured to send its unified track feed in real-time to a downstream system or user.

Furthermore, the additional integration, filtering or enhancement functions can include any of the following functions: (a) when assembling the best location information from the said associated track updates involving a 2D radar sensor and an ADS-B sensor, the altitude information is taken from the associated ADS-B track update; (b) filtering out of said unified track feed track updates generated from said clutter generating phenomenon determined automatically based on track attributes selected to differentiate said updates from those associated with targets of interest such as aircraft or vessels; (c) automatically determining when a target of interest enters one or more defined geo-fences and generating and sending out an alert when this occurs to a remote pilot, display system or service, database, file system, storage device or another post-processor; (d) in said combining or joining of said associated track updates in order to form each unified track feed update, adding to said unified track feed update a field that records: (i) the respective, contributing sensor names associated with said associated track updates in order to allow for the downstream, automated separation and analysis of cooperative and noncooperative targets as well as automated system performance assessment and system performance health monitoring; (ii) the aircraft ICAO Identifier and flight number if an ADS-B sensor is contributing; (iii) the MMSI number and vessel name if an AIS sensor is contributing; and (iv) the drone serial number if a C-UAS sensor is contributing; (e) if said surveillance network is providing said target track data from multiple ADS-B sensors with overlapping coverage, said ADS-B track data streams are first integrated together into a single composite ADS-B track data stream by associating the same ICAO identifier in order to increase update rates and remove multiplicity before generating said unified track feed; (f) if said surveillance network is providing said target track data from multiple AIS sensors with overlapping coverage, said AIS track data streams are first integrated together into a single composite AIS track data stream by associating the same MMSI number in order to increase update rates and remove multiplicity before generating said unified track feed; and (g) if said surveillance network is providing said target track data from multiple C-UAS sensors with overlapping coverage, said C-UAS track data streams are first integrated together into a single composite C-UAS track data stream by associating the same drone serial number in order to increase update rates and remove multiplicity before generating said unified track feed.

In addition, the downstream system or user can be taken from the group of a remote pilot through a data interface, a display system, a service including a UTM service or vessel traffic management service, a database, file system, or storage device, or another post-processor. Finally, the track data interface can be substituted with the target information system described herein.

Another key embodiment is a specialized, real-time radar data processing system for post-processing target track data from a surveillance network with at least one radar sensor for tracking noncooperative aircraft targets and at least one ADS-B sensor for tracking cooperative aircraft targets in the airspace surveyed by said surveillance network, comprising:
1. a track data interface configured to receive continuously in real-time target track data from said surveillance network and making said target track data available for subsequent data processing, said target track data originating from said at least one radar sensor and said at least one ADS-B sensor associated with said surveillance network with each of said sensors generating a respective track data stream and said track data streams collectively making up said target track data, and said radar sensor generating target track data from both noncooperative targets and cooperative targets as well as from clutter generating phenomenon in the environment including birds, precipitation and surface features such as trees, ocean waves and ground vehicles, said noncooperative targets not actively participating in being identified and precisely located in the environment over time, said noncooperative targets taken from the group of crewed and uncrewed aircraft, each said track data stream providing a continuous stream of respective track updates from said surveillance network sent to said track data interface, each respective said track update including a track identifier, date/time stamp, and location information associated with said respective target or said respective clutter generating phenomenon, said target track data thereby including a multiplicity of seemingly unique target tracks which are in fact associated with the same physical target that is active in the environment, said multiplicity increasing as the number of said sensors with overlapping coverage in said surveillance network grows and as the number of active targets in the environment grows, making said target track data more and more confounding to interpret;
2. a surveillance data processor operatively connected to said track data interface and configured to receive said target track data from said track data interface in real-time;
3. said surveillance data processor further configured to automatically process said received target track data in real-time by unifying the collection of said respective track data streams contained in said received target track data into a single unified track feed providing a unified track for each active target tracked by said surveillance network, said unified track representing each said active target with a unique, unified target identifier, and each track update associated with said unified target identifier including a unified target date/time stamp and unified target location information which update continuously over time;
4. said surveillance data processor further configured to include a multi-sensor correlator (MSC) processor and a data unification engine (DUNE) processor which work together to generate said unified track feed;
5. said MSC processor employing correlation algorithms which automatically determine when a given radar track is sufficiently correlated with an ADS-B track thereby establishing a relationship between respective radar/ADS-B track pairs indicating their association with the same cooperative aircraft target;
6. said DUNE processor configured to automatically determine for each received target track data update whether to assign said update to an existing unified track, or whether said update is from a new active target in which case said DUNE processor initiates a new unified track and assigns said update to said new unified track;
7. said DUNE processor further configured to use said relationships established by said MSC processor to (i) reduce said multiplicity of seemingly unique target tracks which are in fact associated with the same physical target and (ii) separate cooperative aircraft from noncooperative aircraft in real-time;

In addition, the surveillance data processor can be further configured to include a TAX-TC processor which operates on said target track data in order to compute one or more target attributes which are used to differentiate between or classify targets to support subsequent post-processing operations. Preferably, the DUNE processor uses said target attributes to filter out from said unified track feed unwanted tracks due to weather, birds or vehicles.

Furthermore, the surveillance data processor can be still further configured to include a radar fusion engine (RFE) processor which operates on target track data from two or more radars with overlapping coverage to determine which of said tracks are associated with the same target and recording those association relationships to support subsequent post-processing operations. Preferably, the DUNE processor uses the association relationships to further reduce said multiplicity of seemingly unique target tracks which are in fact associated with the same physical target.

In an analogous embodiment directed at vessels, said radar sensor for tracking noncooperative aircraft targets is substituted with a radar sensor for tracking noncooperative vessel targets and said ADS-B sensor for tracking cooperative aircraft targets is substituted with an AIS sensor for tracking cooperative vessel targets, and further where said surveillance data processor is directed to processing vessel targets as opposed to aircraft targets.

Yet another key embodiment is a specialized, surveillance data processing system for conducting an automated performance assessment of a radar sensor of a surveillance network using cooperative targets of opportunity tracked by said surveillance network, comprising:
1. a track data interface configured to provide access to target track data from a surveillance network, making said target track data available for subsequent data processing, said target track data including (i) radar track data consisting of individual radar tracks of aircraft tracked by said radar sensor within its region of coverage and (ii) ADS-B track data consisting of individual ADS-B tracks of aircraft provided by an ADS-B sensor or service associated with said surveillance network for said region of coverage;
2. a surveillance data processor being operatively connected to said track data interface and configured to query said track data interface for a set of radar track data from a particular radar sensor and ADS-B track data at least out to the maximum anticipated coverage volume of said radar sensor, both for a specified period of time over which performance is to be assessed, said period of time being on the order of hours, days or even weeks depending on the level of traffic in the airspace of said coverage volume;
3. said surveillance data processor further configured to determine from said set of radar track data and ADS-B track data: (i) those respective radar track(s) that are correlated with each respective ADS-B track thereby forming respective track pairs categorized as being associated with cooperative targets of opportunity tracked by radar, and (ii) those respective radar tracks that are not correlated with any ADS-B tracks and categorized as being associated with noncooperative targets of opportunity tracked by radar;
4. said surveillance data processor further configured to calculate quantifiable radar performance measurements from said radar tracks associated with cooperative targets of opportunity tracked by radar and from said radar tracks associated with said noncooperative targets of opportunity tracked by radar; and
5. said surveillance data processor further configured to execute at least one of the following functions:
   a. process said quantifiable radar performance measurements associated with said cooperative targets of opportunity to establish a radar performance baseline for said radar sensor, representing it's commissioned or properly working state;
   b. process said quantifiable radar performance measurements associated with said cooperative targets of opportunity by comparing the current radar performance represented by said quantifiable radar performance measurements with a previously established radar performance baseline in order to compute a radar health indicator representing the current health of said radar sensor, and to report said radar health indicator to one or more stakeholders or alert them when said radar health indicator indicates that the current health of said radar sensor has degraded;
   c. process said quantifiable radar performance measurements associated with said noncooperative targets of opportunity to establish an expected noncooperative target activity baseline; or
   d. process said quantifiable radar performance measurements associated with said noncooperative targets of opportunity by comparing them with a previously established expected noncooperative target activity baseline and detecting an increase in noncooperative target activity indicative of a material reduction in performance of said ADS-B sensor or service and reporting or alerting said reduction in ADS-B performance to one or more stakeholders.

In another embodiment, said radar sensor is for tracking cooperative and noncooperative vessels in its region of coverage instead of aircraft and said radar track data is from cooperative and noncooperative vessels targets rather than aircraft, and where said ADS-B sensor or service is substituted with an AIS sensor or service to provide track data consisting of individual AIS tracks of cooperative vessels associated with said surveillance network for said region of coverage.

Another key embodiment is a specialized, surveillance data processing system for conducting an automated performance assessment of an ADS-B sensor or service of a surveillance network using cooperative targets of opportunity tracked by said surveillance network, comprising:
1. a track data interface configured to provide access to target track data from a surveillance network, making said target track data available for subsequent data processing, said target track data including ADS-B track data consisting of individual ADS-B tracks of aircraft provided by an ADS-B sensor or service associated with said surveillance network for said region of coverage;
2. a surveillance data processor being operatively connected to said track data interface and configured to query said track data interface for a set of ADS-B track data over a coverage volume of interest for a specified period of time over which ADS-B performance is to be assessed, said period of time being on the order of hours, days or even weeks depending on the level of traffic in the airspace of said coverage volume;
3. said surveillance data processor further configured to calculate quantifiable ADS-B performance measurements from said ADS-B tracks; and
4. said surveillance data processor further configured to execute at least one of the following functions:
   a. process said quantifiable ADS-B performance measurements to establish an ADS-B performance baseline for said ADS-B sensor or service, representing it's commissioned or properly working state;
   b. process said quantifiable ADS-B performance measurements by comparing the current ADS-B performance represented by said quantifiable ADS-B performance measurements with a previously established ADS-B performance baseline in order to compute an ADS-B health indicator representing the current health of said ADS-B sensor or service, and to report said ADS-B health indicator to one or more stakeholders or alert them when said ADS-B health indicator indicates that the current health of said ADS-B sensor or service has degraded.

And said quantifiable ADS-B performance measurements are preferably taken from the group of ADS-B spatial reception maps, ADS-B altitude statistics and range statistics, and the presence of particular, regular ADS-B aircraft traffic expected in particular corridors at particular times.

And in a related embodiment, said ADS-B sensor or service is substituted with an AIS-sensor or service, ADS-B track data is substituted with AIS track data, and ADS-B performance, quantifiable performance measurements, performance baseline and health indicator are substituted with corresponding AIS performance, quantifiable performance measurements, performance baseline and health indicator.

Another key embodiment is an automated, standardized reporting system for characterizing airspace traffic patterns for regulators and remote pilots in command of uncrewed aircraft in support of their risk-based, safety analysis and planning, comprising:
1. a track data interface configured to provide access to target track data from a surveillance network, making said target track data available for subsequent data processing, said target track data including (i) radar track data consisting of individual radar tracks of aircraft tracked by radar within its region of coverage and (ii) ADS-B track data consisting of individual ADS-B tracks of aircraft provided by an ADS-B sensor or service associated with said surveillance network for said region of coverage;
2. a surveillance data processor being operatively connected to said track data interface and configured to query on a regular time interval said track data interface for a set of radar tracks and ADS-B tracks spatially spanning a region at least out to the maximum anticipated radar coverage volume of said surveillance network, and spanning a specified time period, said time period being typically on the order of a day, week or month providing sufficient track data to characterize airspace traffic patterns, and said regular time interval typically matching said time period being respectively daily, weekly or monthly;
3. said radar track data originating from one or more radar sensors, with the tracks associated with each of said radar sensors constituting a respective radar feed;
4. said ADS-B track data originating from one or more ADS-B sensors, with the tracks associated with each of said ADS-B sensors constituting a respective ADS-B feed;
5. said surveillance data processor further configured to include a data unification engine configured to combine said radar feeds and said ADS-B feeds into a single unified track feed;
6. said surveillance data processor further configured to determine from the set of tracks from said unified track feed: (i) those respective radar track(s) that are correlated with each respective ADS-B track thereby forming respective track pairs categorized as being associated with cooperative targets of opportunity tracked by radar, and (ii) those respective radar tracks that are not correlated with any ADS-B tracks and categorized as being associated with noncooperative targets of opportunity tracked by radar; and
7. said surveillance data processor further configured to automatically generate standardized reports which characterize the airspace traffic patterns for cooperative and noncooperative targets through mathematical and graphical analysis of their respective tracks.

Yet another key embodiment is a surveillance system service for certifying portions of the airspace where a surveillance system is capable of meeting a minimum standard for detection and alerting of intruder aircraft, which thereby allows a pilot planning to remotely command an uncrewed aircraft to determine if she can safely operate there, comprising:
1. a track data interface configured to provide access to target track data from a surveillance network, making said target track data available for subsequent data processing, said target track data including (i) radar track data consisting of individual radar tracks of aircraft tracked by radar within its region of coverage and (ii) ADS-B track data consisting of individual ADS-B tracks of aircraft provided by an ADS-B sensor or service associated with said surveillance network for said region of coverage;
2. a surveillance data processor operatively connected to said track data interface and configured to query said track data interface for a set of radar tracks and ADS-B tracks at least out to the maximum anticipated radar coverage volume of said surveillance network;
3. said radar track data originating from one or more radar sensors, with the tracks associated with each of said radar sensors constituting a respective radar feed;
4. said ADS-B track data originating from one or more ADS-B sensors, with the tracks associated with each of said ADS-B sensors constituting a respective ADS-B feed;
5. said surveillance data processor further configured to include a data unification engine configured to combine said radar feeds and said ADS-B feeds into a single unified track feed;
6. said surveillance data processor further configured to generate quantifiable intruder detection performance measurements from said unified track feed, compare them against the minimum required certification standard and report back to a user whether a particular region or regions of the airspace are certified as meeting a minimum standard for detection and alerting of intruder aircraft;
7. a user interface configured to allow said pilot to make a certification request to said surveillance system service by specifying a particular go safe volume region for said service to certify or by requesting said service to report one or more regions of airspace it can certify as meeting a minimum standard for detection and alerting of intruder aircraft in said region or regions.

Yet another key embodiment is a drone operations compliance reporting system which automatically assesses the extent to which authorized uncrewed aircraft systems have been compliant with their respective operating regulations, comprising:
1. a track data interface configured to provide access to target track data from a surveillance network, making said target track data available for subsequent data processing, said target track data including (i) radar track data consisting of individual radar tracks of aircraft tracked by radar within its region of coverage and/or (ii) ADS-B track data consisting of individual ADS-B tracks of aircraft provided by an ADS-B sensor or service associated with said surveillance network for said region of coverage;
2. said track data interface further configured to provide access to uncrewed aircraft GPS data organized in the form of uncrewed aircraft tracks including a unique identifier such as serial number to identify each uncrewed aircraft; and
3. a surveillance data processor being operatively connected to said track data interface and configured to query on a regular time interval said track data interface for a set of uncrewed aircraft tracks along with a set of radar tracks and ADS-B tracks spatially spanning a region typically out to the maximum anticipated radar coverage volume of said surveillance network, and spanning a specified time period, said time period being typically on the order of a day, week or month and said regular time interval typically matching said time period being respectively daily, weekly or monthly;
4. said radar track data originating from one or more radar sensors, with the tracks associated with each of said radar sensors constituting a respective radar feed;
5. said ADS-B track data originating from one or more ADS-B sensors, with the tracks associated with each of said ADS-B sensors constituting a respective ADS-B feed;
6. and said uncrewed aircraft tracks constituting an uncrewed aircraft feed;
7. said surveillance data processor further configured to include a data unification engine, said data unification engine configured to combine said radar feeds and said ADS-B feeds into a single unified feed;
8. said surveillance data processor further configured to measure the distance of closest approach between each uncrewed aircraft track in the uncrewed aircraft feed and each respective cooperative and noncooperative aircraft track in the unified feed at each instant in time, and (i) tabulate those distances over time, characterize them statistically and report on them, and (ii) report on each instance of loss-of-well-clear, noting the uncrewed aircraft identifier, the unified feed aircraft identifier and date and time.

The above drone operations compliance reporting system can be further adapted for the near real-time alerting to authorities of drone non-compliance with UAS operating regulations as well as suspicious drone activity that may be a security threat allowing for an immediate response, where:
a. said track data interface is further configured to provide access to noncooperative uncrewed aircraft tracks derived originating from a C-UAS sensor including a unique identifier such as serial number to identify each noncooperative uncrewed aircraft;
b. said regular time interval and time period are on the order of a minute to facilitate near real-time alerting;
c. said reporting on each instance of loss-of-well-clear including loss-of-well-clear between a pair of noncooperative uncrewed aircraft;
d. said surveillance data processor further configured to detect and alert on suspicious drone activity associated with noncooperative uncrewed aircraft, including loitering behavior, border crossings and breaches of facility perimeters where drones must be kept out of due to security concerns; and
e. said report using means like e-mail, SMS and other direct means of communication to alert authorities for immediate response.

The aforementioned embodiments involve a non-human information processing system devised to automatically search, extract, analyze, organize, and re-configure radar data, ADS-B data, and C-UAS data to render it in a form that reduces operator overload and is cognizable by the human intellect. The systems and methods of the present disclosures are directed to machines or technology that aids human activity, by accomplishing something that the human mind cannot realistically handle. In particular, the present disclosures deal with radar, ADS-B, C-UAS RF sensors, Remote ID, and AIS data to:
1. assist human beings in automatically conducting risk and compliance assessments for uncrewed operations;
2. give RPICs the situational awareness they need to remotely and safely operate their uncrewed vehicles BVLOS and stay well clear of other crewed and uncrewed vehicles; and
3. ensure the surveillance network that is relied upon to enable these capabilities has not degraded from its designed performance.

These capabilities are new and do not exist in existing ATC, C-UAS and VTS systems.

Due to the extensive volume aircraft and vessel traffic and their associated tracks from radar, ADS-B, C-UAS, RemoteID and AIS sensors, the specialized post-processing methods taught herein cannot be performed by the human mind in any practical or realistic sense. The embodiments are directed to big data machine activity outside the scope of human capabilities and consequently significant to the supplementation of human cognition, extending technology to where human capabilities cannot go on their own.

The disclosures constitute major technical improvements to the radar, ADS-B, C-UAS and AIS data processing functionality of a surveillance system or surveillance network (which can be thought of as a system of systems). In one embodiment, two specialized computers are provided, the first one interfacing with the surveillance network or its real-time track database for post-processing its real-time track data to provide real-time situational awareness and detect and alert functions, and the second one interfacing with the surveillance network's historical track database for automated big data analytics processing in support of non-real-time functions. The real-time track database and the historical track database can be the same. The real-time specialized computer incorporates the MSC and DUNE processors and preferably the TAX-TC processor as illustrated in FIG. 2. The big data analytics computer preferably incorporates the specialized SPA processor, standardized reporting processor, certification processor and/or system health monitoring and alerting processor to implement their respective functionality as described earlier.

Although a single specialized computer could be used to implement all of the taught functionality, using two separate specialized computers certain advantages. First, they can be sized differently in terms of memory, processing power and storage to better match the real-time versus big data functionality. Second, latency can be better managed for the real-time computer. Third, a hybrid cloud computing and private data center model could be adopted where the expensive big data storage may be more affordably managed in a private data center, and the real-time cloud hosting may be better suited for the real-time functionality with the highest availability. Each specialized computer can be implemented using virtual machines, multiple processing cores, network storage, different operating systems, and various cyber security approaches known to those skilled in the art. The flexibility in how the various real-time and analytical/historical functionality could be implemented is advantageous from a business or economic sense as well, as commercial rollout of a regional, state or even national surveillance network infrastructure is very uncertain, risky and expensive. Furthermore, different owners and users may be associated with different components of the smart surveillance network. For example, one or more owners of may be associated with the sensor network infrastructure; and track feeds from different sensors might be licensed to other service providers, parties associated with the specialized processing functionality, and/or direct users. The specialized processing could be implemented by one party or multiple parties providing different specialized functions; and the associated data could be used by one or more of the parties, and/or provided directly or by license as one or more services to multiple parties including UTM operators, end users, other industry players and regulators.

It should be obvious to those skilled in the art that additional specialized functions could be added to the smart surveillance networks disclosed herein to supplement the particular specialized functions and processing taught herein. For example, one could further certify an airspace as being suitable for a proposed drone flight or operational volume by simply adding a specialized processor to assess and confirm that a suitable communications link (using for example different cellular services from communications service providers, land-based communication networks and/or SATCOM services) would be available to reliably command and control (C2) the drone throughout its proposed flight or flights. And specialized C2 health monitoring and/or standardized C2 link reporting could be added to supplement the specialized surveillance system health monitoring functionality and airspace standardized reporting described herein. Ground surveillance capabilities could also be added to the smart surveillance network to provide for physical security of the surveillance sensor infrastructure, and security breaches could be alerted and reported in an analogous fashion as C-UAS threats are in accordance with the teaching provided herein.

It should be noted that today, virtually all drones are noncooperative targets in the context of the systems described herein. They do not typically broadcast their identification (ID) and location to relevant authorities. The United States Federal Aviation Administration (FAA) Remote ID program will help regulate drones of a certain size by requiring them to broadcast their ID/location to authorities. RemoteID is designed typically to be picked up at short range so drones a mile away or more will likely not be detected. Even with the regulations now in effect, many drones will likely not comply and remain as noncooperative targets. Operators of drones intending to conduct criminal activities will disable or not implement such ID/location broadcast features. For example, noncooperative drones could be used in the context of critical infrastructure such as a bridge, transmission lines and substations, nuclear facility, or a stadium where the drone operator could have criminal intent to cause harm, for example with an explosive payload. Drones can also be used for delivering contraband into prisons (fly over and drop). Drones may also carry out reconnaissance at stand-off distances and interfere with DFR and law enforcement operations which is already a growing concern by law enforcement and emergency response personnel.

In embodiments described earlier, C-UAS sensors are included in the BVLOS surveillance network to provide awareness of such noncooperative drones which are a source of added risk for air-to-air collisions as well as security concerns, especially as their numbers increase. Criminal drones will “hide in the crowd” to go unnoticed in the presence of a multitude of other drones as they carry out their nefarious activities.

In another embodiment, an RPIC-operated drone could be automatically directed by a real-time alerting function associated with a specialized surveillance data processor to put “eyes” on a suspicious drone by navigating close enough to it and using the on-board camera of the RPIC-operated drone to provide a real-time view to authorities, which could indicate for example whether the drone was carrying a payload. Furthermore, drones could be determined to be suspicious in part by an automatic query made by a specialized surveillance data processor to a service which authorizes drone flights, providing the service with a drone of interest's serial number (and possibly location information) and receiving back from the service a yes or no indicating whether the specified drone was authorized. Suspicious drones of interest could also have their track symbology automatically color-coded or adorned by an ornament on the COP to indicate to operators that this is a target of interest.

In yet another embodiment, a real-time, specialized surveillance data processor has an automatic function which inhibits the ability of an operator or control circuit to execute a mitigation against a suspicious drone or a drone which appears to be out of control if it is unsafe to do so. The unsafe condition is determined by an automatic examination by the specialized surveillance data processor of the crewed and uncrewed aircraft in the vicinity of the drone-to-be-mitigated and the ground traffic below that drone (e.g., if its location is over a highway or busy road for example) and a determination of whether the mitigation could negatively interfere with electronic systems onboard the nearby aircraft or sensors at other nearby facilities or cause an accident as a result of the actual air risk or ground risk at the time of the mitigation. The mitigations are taken for example from the group of jamming the drone/controller, taking over control of the drone, causing the drone to return to its home position, causing the drone to go to a pre-determined location, or establishing a virtual fence which blocks the drone from advancing past it.

A target information system (TIS) preferably operatively connected to a smart surveillance network and provides access to real-time and historical aircraft tracks and/or vessel tracks generated by and received from one or more radars, and preferably all other sensors, of said smart surveillance network. In a preferred embodiment, the TIS includes one or more databases, including structured query language (SQL) databases, that organize the real-time and historical radar track data in a manner that facilities rapid queries over long periods of time at least on the order of several hours or days, in support of the required fast turn-around time for generating the historical data reporting. This fast turn-around time is important, especially for the degradation of performance of the surveillance network, so that RPICs can suspend uncrewed operations until performance can be restored. See U.S. Pat. Nos. 10,101,437 and 9,291,707 B2 (FIG. 4) which are incorporated herein by reference for target information system designs. The same TIS design can be used for the ADS-B and C-UAS sensor data as well, received from the surveillance network.

While the use of a TIS is preferred because of the flexibility it offers, a TIS is not required in order to support the execution of the specialized surveillance data processing functions taught herein; and any track data interface configured to receive continuously in real-time the required target track data from the surveillance network and/or the historical target track data and/or DUNE unified feed and make them available for the subsequent real-time data processing and specialized historical data processing as taught herein will suffice. Indeed, multiple track data interfaces could be use for different specific specialized data processing functions taught herein. Therefore, unless the context requires it, a track data interface can be substituted for the TIS as used herein.

AI techniques can provide additional capabilities compatible with the specialized surveillance data processing described herein.

A feature of an embodiment is to use AI processing to automatically classify camera/video data that is associated with radar tracks operated on by the TAX-TC. In this case, image recognition algorithms are used to automatically determine the type of target (e.g., weather, bird, aircraft, vehicle, vessel, etc.) being tracked.

Much like the human brain uses multiple senses to understand its environment, so too can a TAX-TC processor. Whereas radar does an excellent job detecting and tracking targets of interest, providing their location, velocity and radar cross section (RCS) over time, cameras add identifying information by providing photographs or videos of the target. The target camera data is preferably made available to the TAX-TC from the TIS, although the TAX-TC could alternatively obtain the camera data directly from another source. Alternatively, the AI target classifications themselves could be made available to the TAX-TC as another preferred embodiment, which reduces the bandwidth and processing required by the TAX-TC. For the purposes of the ensuring AI discussion, one or more of the candidate tracks provided by the TIS to the TAX-TC includes respective, associated camera photos and/or video clips which show the respective targets being tracked, or alternatively the target classification(s) determined from the photos/video clips.

In another embodiment, radar data is processed by the TAX-TC with the help of artificial intelligence (AI) processing to rapidly classify the radar track data, and camera/video data when available, as provided by the TIS. Camera frames (i.e., photos) and short video clips are captured by the smart surveillance network by using automatic slew-to-cue techniques knows to those skilled in the art to direct a camera to follow a target either because an operator has selected the target, the target has entered an area of interest, the target is exhibiting a behavior of interest (e.g., breaking a speed limit) or the camera has been place in a patrol mode where the camera automatically selects or is provided with radar tracks or drone tracks within its vicinity and slew-to-cues (i.e. pan-tilt-zooms over to the current target track location and uses the track updates to make fine adjustments to keep the target in the field of view of the camera) to each track for a quick camera/video capture before moving on to the next target track.

Objects in the camera/video frames are automatically detected, bounded with a bounding box, and matched by the AI against an existing third-party library, or one learned over time by the AI based on real data from the smart surveillance network.

The AI processing in accordance with an embodiment may use automatic target behavior recognition algorithms and video target classification algorithms. Target behavior recognition algorithms recognize that birds, weather, and general aviation aircraft behave differently which is reflected in their respective radar tracks evidenced by their respective dynamics in terms of speed distributions, maximum speed, acceleration distributions, heading distributions, sinuosity, and RCS. And the same is true for differentiating among vessels where the behavior of a jet ski, sailboat or cabin cruiser is quite different. See for example U.S. Pat. No. 11/733,374B2 which is incorporated herein by reference.

An AI processor may learn each of these target behaviors using actual radar track training data, for example, with supervised learning where the radar tracks used for training have been classified into the different target types. The target behavior recognition algorithms effectively compare and score the candidate tracks against the known target types using a variety AI or pattern recognition algorithms.

AI can also be applied to learn and identify target behaviors using track data to differentiate types of aircraft based on their behavior (e.g. a helicopter versus a crop duster) and the same is true for different types of vessels for the USV application (e.g., a sailboat versus a cabin cruiser).

Preferably, track data that has been automatically classified as to target type using the associated camera/video data may also be used by the TAX-TC in combination with the aforementioned AI-based target behavior algorithms to better select candidate tracks that are more likely to be associated with TOIs. In addition, track-stitching techniques may be used to further improve the classification process.

Those skilled in the art will appreciate that there are numerous ways that the AI processor can be implemented which are all contemplated in this disclosure. The AI algorithms can include, for example, open-loop rule-based or fixed-model engines as well as complex machine learning algorithms for the specialized data processors. Open-loop AI algorithms use target models and sensor data models that may be trained from real-world sensor data, but which are non-self-adapting once trained and configured. The models represent various expected behaviors or patterns associated with the sensor data and may be used, in accordance with an embodiment, in various behavior/pattern recognition techniques to estimate, predict or classify candidate radar track and camera data. Machine learning AI algorithms, on the other hand, have feedback in them and use past decisions to automatically learn the efficacy of the underlying models and adapt the models based on new radar and camera data to improve performance.

Machine learning can employ a variety of learning algorithms including supervised and un-supervised learning, as well as other forms such as reinforcement learning. The supervised learning algorithms may be applied, for example, in the regression (e.g., track stitching, target behavior) and classification (e.g., camera data target type) processing described above. However, unsupervised learning (e.g., K-means) may also be used, for example to cluster, for example, general aviation tracks or weather tracks exhibiting similar target behavior.

The TIS historical data and real-time data may serve as a useful repository of training data to initially (and periodically—e.g., once per year) instruct or train the AI processing and to continuously refine the AI processing, accounting for the actual performance of the specialized processors described herein, as well as various local weather, topography, interference, coverage and target conditions that may be experienced in a particular area.

Additionally, as the DUNE allows for the automatic differentiation of radar tracks associated with particular ADS-B tracks for aircraft of opportunity flying in the airspace (i.e., no expensive deployments of aircraft as test targets and various flight patterns exhibiting different behaviors required; simply capture the behaviors from the environment over time), the MSC/DUNE can automatically provide good radar training data for the AI, which is a significant new capability given the vastness of radar data. This automatic generation of radar training data for different types of aircraft can also be applied in an analogous for classifying different types of drones using drones of opportunity flying in the airspace. Tracks from drone tracking radar as well as tracks from C-UAS RF receivers can be automatically grouped into training sets for different drone models. For this case, RemoteID or deep signal inspection methods (available in many C-UAS RF receivers) can often identify the drone model.

Finally, AI can also be used in the automated system health monitoring and degradation alerting functions taught herein. For example, the radar and ADS-B sensor performance baselines established following commissioning as illustrated in FIG. 3, FIG. 4, FIG. 5 and FIG. 6 can be automatically compared against similar images generated as part of the ongoing SPA and health monitoring processing, and AI can be used to automatically detect significant performance degradation by comparing the respect image pairs.

A network may be used to operatively connect system data processors, including a data communication network or simply inter-process communication within a computer system, a local area network, wide area network, Internet, public network, private network, wired network or wireless network of any type. Processors or controllers may be implemented on a single computer or multiple computers of any type including virtual machines and Cloud computing.

Radar sensors and radar networks may be any type of 2D and/or 3D radar that generates radar tracks of noncooperative targets such as general aviation aircraft including drones and/or small recreational vessels, and provides “raw” radar data in real-time as aircraft tracks and/or vessel tracks to the target information system. Typical radar track update rates are on the order of a few seconds or less, allowing for good tracking of small uncooperative targets. See U.S. Pat. Nos. 7,940,206 B2 and 8,860,602 B2 which are incorporated herein by reference for examples of radar networks and see U.S. Pat. No. 9,291,707 B2 which is incorporated herein by reference for examples of 3D avian radars which are included in the types of radars that are contemplated in an embodiment.

Particular features of embodiments have been described herein. However, variations and extensions known to those skilled in the art are certainly within the scope and spirit of the present disclosure. This includes variations on integration of the functional blocks described herein.

Data flows may be implemented using standard methods and messaging formats and protocols. Software and user interfaces may be implemented using software implementation including thin and thick applications, mobile applications, Web services and browser applications. Servers may be implemented using a variety of server implementations including stand-alone Windows™ or Linux servers, virtual servers, cloud servers. Databases (e.g. SQL and GraphQL), geographic information systems and other approaches known to those skilled in the art can be used to organize surveillance target data, relationships between various track data streams, quantifiable measures, traffic patterns, et cetera described herein. Processors can be implemented using known technologies including general purpose computing, embedded computing, digital signal processors and chip sets, cloud services.

Those skilled in the art will appreciate that the systems and methods described herein can be used in any application that involves non-cooperative and/or co-operative crewed or uncrewed vehicles where pilots, regulators are stakeholders are engaged in reducing the likelihood of accidents or security incidents by ensuring that vehicles stay well clear of each other and/or well clear of facilities of concern.

What is claimed is:

1. A smart, real-time radar data processing system for assisting remote pilots in command of uncrewed vehicles beyond their visual line of sight to avoid collisions with other crewed or uncrewed vehicles in their vicinity where said vehicles are aircraft, vessels or automobiles, comprising:
a. a track data interface configured to receive continuously in real-time target track data from a surveillance network and making said target track data available for subsequent data processing, said target track data originating from at least two sensors associated with said surveillance network with each of said sensors generating a respective track data stream and said track data streams collectively making up said target track data, said sensors taken from the group of radar, cameras, C-UAS receivers, ADS-B receivers, RemoteID receivers, and AIS receivers, said ADS-B, RemoteID and AIS receivers generating target track data from cooperative targets in the environment taken from the group of crewed and uncrewed aircraft, vessels and automobiles, and who broadcast their respective identity and precise location regularly over time, and said radar, cameras and C-UAS receivers generating target track data from the group of noncooperative targets, cooperative targets, and clutter generating phenomenon in the environment, said clutter generating phenomenon taken from the group of birds, precipitation and surface features such as trees and ocean waves, said noncooperative targets not actively participating in being identified and precisely located in the environment over time, said noncooperative targets also taken from the group of crewed and uncrewed aircraft, vessels and automobiles, each said track data stream providing a continuous stream of track updates from said cooperative targets, noncooperative targets and clutter generating phenomenon tracked by said surveillance network and sent to said track data interface, each respective said track update including a track identifier, date/time stamp, and location information associated with said respective target or said respective clutter generating phenomenon, said target track data thereby including a multiplicity of seemingly unique target tracks which are in fact associated with the same physical target that is active in the environment, said multiplicity increasing as the number of said sensors with overlapping coverage in said surveillance network grows and as the number of active targets in the environment grows, making said target track data more and more confounding to interpret;
b. a surveillance data processor operatively connected to said track data interface and configured to receive said target track data from said track data interface in real-time;
c. said surveillance data processor further configured to automatically process said received target track data in real-time by unifying the collection of said respective track data streams contained in said received target track data into a single unified track feed, said unified track feed representing each said active target with a unique, unified target identifier, and each track update associated with said unified target identifier including a unified target date/time stamp and unified target location information which update continuously over time, said unified track feed generated by said surveillance data processor by the automatic (i) determination of the said multiplicity of unique tracks associated with each physical target using multi-sensor processing algorithms taken from the group of cross-correlation algorithms and fusion algorithms on a time update by time update basis to identify those track updates from said received target track data which are associated with the same target, and (ii) combining or joining of said associated track updates in order to form each unified track feed update by extracting and assembling the best target location information available from the said associated track updates;
d. said surveillance data processor further configured to automatically process said unified track feed by performing additional integration, filtering or enhancement functions whose purpose is to improve said unified track feed data quality;
e. and said surveillance data processor further configured to send its unified track feed in real-time to a downstream system or user.

2. The system of claim 1 where said additional integration, filtering or enhancement functions includes at least one of the following functions:
a. when assembling the best location information from the said associated track updates involving a 2D radar sensor and an ADS-B sensor, the altitude information is taken from the associated ADS-B track update;
b. filtering out of said unified track feed track updates generated from said clutter generating phenomenon determined automatically based on track attributes selected to differentiate said updates from those associated with targets of interest such as aircraft or vessels;
c. automatically determining when a target of interest enters one or more defined geo-fences and generating and sending out an alert when this occurs to a remote pilot, display system or service, database, file system, storage device or another post-processor;
d. in said combining or joining of said associated track updates in order to form each unified track feed update, adding to said unified track feed update a field that records:
i. the respective, contributing sensor names associated with said associated track updates in order to allow for the downstream, automated separation and analysis of cooperative and noncooperative targets as well as automated system performance assessment and system performance health monitoring;
ii. the aircraft ICAO Identifier and flight number if an ADS-B sensor is contributing;
iii. the MMSI number and vessel name if an AIS sensor is contributing; and
iv. the drone serial number if a C-UAS sensor is contributing;
e. if said surveillance network is providing said target track data from multiple ADS-B sensors with overlapping coverage, said ADS-B track data streams are first integrated together into a single composite ADS-B track data stream by associating the same ICAO identifier in order to increase update rates and remove multiplicity before generating said unified track feed;
f. if said surveillance network is providing said target track data from multiple AIS sensors with overlapping coverage, said AIS track data streams are first integrated together into a single composite AIS track data stream by associating the same MMSI number in order to increase update rates and remove multiplicity before generating said unified track feed; and
g. if said surveillance network is providing said target track data from multiple C-UAS sensors with overlapping coverage, said C-UAS track data streams are first integrated together into a single composite C-UAS track data stream by associating the same drone serial number in order to increase update rates and remove multiplicity before generating said unified track feed.

3. The system of claim 1 where said downstream system or user is taken from the group of:
i. a remote pilot through a data interface;
ii. a display system
iii. a service including a UTM service or vessel traffic service;
iv. a database, file system, or storage device; or
v. another post-processor.

4. The system of claim 1 where said track data interface is a target information system.

5. A specialized, real-time radar data processing system for post-processing target track data from a surveillance network with at least one radar sensor for tracking noncooperative aircraft targets and at least one ADS-B sensor for tracking cooperative aircraft targets in the airspace surveyed by said surveillance network, comprising:
a. a track data interface configured to receive continuously in real-time target track data from said surveillance network and making said target track data available for subsequent data processing, said target track data originating from said at least one radar sensor and said at least one ADS-B sensor associated with said surveillance network with each of said sensors generating a respective track data stream and said track data streams collectively making up said target track data, and said radar sensor generating target track data from both noncooperative targets and cooperative targets as well as from clutter generating phenomenon in the environment including birds, precipitation and surface features such as trees, ocean waves and ground vehicles, said noncooperative targets not actively participating in being identified and precisely located in the environment over time, said noncooperative targets taken from the group of crewed and uncrewed aircraft, each said track data stream providing a continuous stream of respective track updates from said surveillance network sent to said track data interface, each respective said track update including a track identifier, date/time stamp, and location information associated with said respective target or said respective clutter generating phenomenon, said target track data thereby including a multiplicity of seemingly unique target tracks which are in fact associated with the same physical target that is active in the environment, said multiplicity increasing as the number of said sensors with overlapping coverage in said surveillance network grows and as the number of active targets in the environment grows, making said target track data more and more confounding to interpret;
b. a surveillance data processor operatively connected to said track data interface and configured to receive said target track data from said track data interface in real-time;
c. said surveillance data processor further configured to automatically process said received target track data in real-time by unifying the collection of said respective track data streams contained in said received target track data into a single unified track feed providing a unified track for each active target tracked by said surveillance network, said unified track representing each said active target with a unique, unified target identifier, and each track update associated with said unified target identifier including a unified target date/time stamp and unified target location information which update continuously over time;
d. said surveillance data processor further configured to include a multi-sensor correlator (MSC) processor and a data unification engine (DUNE) processor which work together to generate said unified track feed;
e. said MSC processor employing correlation algorithms which automatically determine when a given radar track is sufficiently correlated with an ADS-B track thereby establishing a relationship between respective radar/ADS-B track pairs indicating their association with the same cooperative aircraft target;
f. said DUNE processor configured to automatically determine for each received target track data update whether to assign said update to an existing unified track, or whether said update is from a new active target in which case said DUNE processor initiates a new unified track and assigns said update to said new unified track;
g. said DUNE processor further configured to use said relationships established by said MSC processor to (i) reduce said multiplicity of seemingly unique target tracks which are in fact associated with the same physical target and (ii) separate cooperative aircraft from noncooperative aircraft in real-time.

6. The system in claim 5 where said surveillance data processor is further configured to include a TAX-TC processor which operates on said target track data in order to compute one or more target attributes which are used to differentiate between or classify targets to support subsequent post-processing operations.

7. The system of claim 5 where said surveillance data processor is further configured to include a radar fusion engine (RFE) processor which operates on target track data from two or more radars with overlapping coverage to determine which of said tracks are associated with the same target and recording those association relationships to support subsequent post-processing operations.

8. The system in claim 6 where said DUNE processor uses said target attributes to filter out from said unified track feed unwanted tracks due to weather, birds or vehicles.

9. The system in claim 7 where said DUNE processor uses said association relationships to further reduce said multiplicity of seemingly unique target tracks which are in fact associated with the same physical target.

10. The system of claim 5 where said radar sensor for tracking noncooperative aircraft targets is substituted with a radar sensor for tracking noncooperative vessel targets and said ADS-B sensor for tracking cooperative aircraft targets is substituted with an AIS sensor for tracking cooperative vessel targets, and further where said surveillance data processor is directed to processing vessel targets as opposed to aircraft targets.

11. A method of smart, real-time radar processing for assisting remote pilots in command of uncrewed vehicles beyond their visual line of sigh to avoid collisions with other crewed or uncrewed vehicles in their vicinity where said vehicles are aircraft, vessels or automobiles, comprising
a. receiving continuously in real-time target track data from a surveillance network and making said target track data available for subsequent data processing, said target track data originating from at least two sensors associated with said surveillance network with each of said sensors generating a respective track data stream and said track data streams collectively making up said target track data, said sensors taken from the group of radar, cameras, C-UAS receivers, ADS-B receivers, RemoteID receivers, and AIS receivers, said ADS-B, RemoteID and AIS receivers generating target track data from cooperative targets in the environment taken from the group of crewed and uncrewed aircraft, vessels and automobiles, and who broadcast their respective identity and precise location regularly over time, and said radar, cameras and C-UAS receivers generating target track data from the group of noncooperative targets, cooperative targets, and clutter generating phenomenon in the environment, said clutter generating phenomenon taken from the group of birds, precipitation and surface features such as trees and ocean waves, said noncooperative targets not actively participating in being identified and precisely located in the environment over time, said noncooperative targets also taken from the group of crewed and uncrewed aircraft, vessels and automobiles, each said track data stream providing a continuous stream of track updates from said cooperative targets, noncooperative targets and clutter generating phenomenon tracked by said surveillance network and sent to said track data interface, each respective said track update including a track identifier, date/time stamp, and location information associated with said respective target or said respective clutter generating phenomenon, said target track data thereby including a multiplicity of seemingly unique target tracks which are in fact associated with the same physical target that is active in the environment, said multiplicity increasing as the number of said sensors with overlapping coverage in said surveillance network grows and as the number of active targets in the environment grows, making said target track data more and more confounding to interpret;
b. receiving said target track data in real-time;
c. processing said received target track data in real-time by unifying the collection of said respective track data streams contained in said received target track data into a single unified track feed, said unified track feed representing each said active target with a unique, unified target identifier, and each track update associated with said unified target identifier including a unified target date/time stamp and unified target location information which update continuously over time, said unified track feed generated by said surveillance data processor by the automatic (i) determination of the said multiplicity of unique tracks associated with each physical target using multi-sensor processing algorithms taken from the group of cross-correlation algorithms and fusion algorithms on a time update by time update basis to identify those track updates from said received target track data which are associated with the same target, and (ii) combining or joining of said associated track updates in order to form each unified track feed update by extracting and assembling the best target location information available from the said associated track updates;
d. automatically processing said unified track feed by performing additional integration, filtering or enhancement functions whose purpose is to improve said unified track feed data quality; and
e. sending the unified track feed in real-time to a downstream system or user.

12. The method of claim 11 where said additional integration, filtering or enhancement functions includes at least one of the following functions:
a. when assembling the best location information from the said associated track updates involving a 2D radar sensor and an ADS-B sensor, the altitude information is taken from the associated ADS-B track update;
b. filtering out of said unified track feed track updates generated from said clutter generating phenomenon determined automatically based on track attributes selected to differentiate said updates from those associated with targets of interest such as aircraft or vessels;
c. automatically determining when a target of interest enters one or more defined geo-fences and generating and sending out an alert when this occurs to a remote pilot, display system or service, database, file system, storage device or another post-processor;
d. in said combining or joining of said associated track updates in order to form each unified track feed update, adding to said unified track feed update a field that records:
i. the respective, contributing sensor names associated with said associated track updates in order to allow for the downstream, automated separation and analysis of cooperative and noncooperative targets as well as automated system performance assessment and system performance health monitoring;
ii. the aircraft ICAO Identifier and flight number if an ADS-B sensor is contributing;
iii. the MMSI number and vessel name if an AIS sensor is contributing; and
iv. the drone serial number if a C-UAS sensor is contributing;
e. if said surveillance network is providing said target track data from multiple ADS-B sensors with overlapping coverage, said ADS-B track data streams are first integrated together into a single composite ADS-B track data stream by associating the same ICAO identifier in order to increase update rates and remove multiplicity before generating said unified track feed;
f. if said surveillance network is providing said target track data from multiple AIS sensors with overlapping coverage, said AIS track data streams are first integrated together into a single composite AIS track data stream by associating the same MMSI number in order to increase update rates and remove multiplicity before generating said unified track feed; and
g. if said surveillance network is providing said target track data from multiple C-UAS sensors with overlapping coverage, said C-UAS track data streams are first integrated together into a single composite C-UAS track data stream by associating the same drone serial number in order to increase update rates and remove multiplicity before generating said unified track feed.

13. The method of claim 1 where said downstream system or user is taken from the group of:
i. a remote pilot through a data interface;
ii. a display system
iii. a service including a UTM service or vessel traffic service;
iv. a database, file system, or storage device; or
v. another post-processor.

14. The system of claim 1 where said track data interface is a target information system.

15. A method of specialized, real-time radar data processing for post-processing target track data from a surveillance network with at least one radar sensor for tracking noncooperative aircraft targets and at least one ADS-B sensor for tracking cooperative aircraft targets in the airspace surveyed by said surveillance network, comprising:
a. receiving continuously in real-time target track data from said surveillance network and making said target track data available for subsequent data processing, said target track data originating from said at least one radar sensor and said at least one ADS-B sensor associated with said surveillance network with each of said sensors generating a respective track data stream and said track data streams collectively making up said target track data, and said radar sensor generating target track data from both noncooperative targets and cooperative targets as well as from clutter generating phenomenon in the environment including birds, precipitation and surface features such as trees, ocean waves and ground vehicles, said noncooperative targets not actively participating in being identified and precisely located in the environment over time, said noncooperative targets taken from the group of crewed and uncrewed aircraft, each said track data stream providing a continuous stream of respective track updates from said surveillance network sent to said track data interface, each respective said track update including a track identifier, date/time stamp, and location information associated with said respective target or said respective clutter generating phenomenon, said target track data thereby including a multiplicity of seemingly unique target tracks which are in fact associated with the same physical target that is active in the environment, said multiplicity increasing as the number of said sensors with overlapping coverage in said surveillance network grows and as the number of active targets in the environment grows, making said target track data more and more confounding to interpret;
b. receiving said target track data in real-time;
c. automatically processing said received target track data in real-time by unifying the collection of said respective track data streams contained in said received target track data into a single unified track feed providing a unified track for each active target tracked by said surveillance network, said unified track representing each said active target with a unique, unified target identifier, and each track update associated with said unified target identifier including a unified target date/time stamp and unified target location information which update continuously over time;
d. automatically determining when a given radar track is sufficiently correlated with an ADS-B track thereby establishing a relationship between respective radar/ADS-B track pairs indicating their association with the same cooperative aircraft target;
e. automatically determining for each received target track data update whether to assign said update to an existing unified track, or whether said update is from a new active target and initiating a new unified track and assigns said update to said new unified track;
f. reducing said multiplicity of seemingly unique target tracks which are in fact associated with the same physical target; and
g. separating cooperative aircraft from noncooperative aircraft in real-time.

16. The method of claim 15 further comprising computing one or more target attributes which are used to differentiate between or classify targets to support subsequent post-processing operations.

17. The method of claim 15 further comprising using a radar fusion engine (RFE) processor operating on target track data from two or more radars with overlapping coverage to determine which of said tracks are associated with the same target and recording those association relationships to support subsequent post-processing operations.

18. The method of claim 16 further comprising filtering out from said unified track feed unwanted tracks due to weather, birds or vehicles.

19. The method of claim 17 further comprising reducing said multiplicity of seemingly unique target tracks which are in fact associated with the same physical target.

20. The method of claim 15 where said radar sensor for tracking noncooperative aircraft targets is substituted with a radar sensor for tracking noncooperative vessel targets and said ADS-B sensor for tracking cooperative aircraft targets is substituted with an AIS sensor for tracking cooperative vessel targets, and further where said surveillance data processor is directed to processing vessel targets as opposed to aircraft targets.
